(19) United States
(12) Patent Application Publication
(10) Pub. No.: US 2011/0135162 A1
(43) Pub. Date: Jun. 9, 2011

(54) IMAGE PROCESSING APPARATUS, IMAGE PROCESSING METHOD AND RECORDING MEDIUM

(75) Inventor: Kimimori Eguchi, Kawasaki-shi (JP)

(73) Assignee: CANON KABUSHIKI KAISHA, Tokyo (JP)

(21) Appl. No.: 12/958,215

(22) Filed: Dec. 1, 2010

(30) Foreign Application Priority Data
Dec. 9, 2009 (JP) 2009-279578

(51) Int. Cl. G06K 9/00

(52) U.S. Cl. 382/112

(57) ABSTRACT

An image processing apparatus according to the present invention comprises, a form registration component configured to register a plurality of document forms; a characteristic amount generation component configured to generate respective characteristic amounts of the plurality of the document forms registered in the form registration component; a representative characteristic amount extraction component configured to extract a difference between the plurality of the document forms as a representative characteristic amount which is used for identifying the forms, by using the generated characteristic amount; a reading component configured to read a document to be checked; and a form determination component configured to determine which document form among the plurality of document forms registered in the form registration component corresponds to the document to be checked that is read by the reading component, by using the representative characteristic amount extracted by the representative characteristic amount extraction component.

### BACKGROUND OF THE INVENTION

1. Field of the Invention

The present invention relates to an image processing apparatus, an image processing method and a recording medium which read a document to determine a form (a template or a format) of the document.

2. Description of the Related Art

There is conventionally known the technology of reading documents (bundle) such as reports by a scanner to calculate the amounts of money, dates and the like described in the respective documents.

In regard with this, there is known the technology of reading an instruction describing information showing the position of a data to be processed on a document and the processing content on the document by a scanner to recognize the positional information of the data to be processed and the processing content, thus performing the processing corresponding to the document. For example, Japanese Patent Laid-Open No. 2008-145611 discloses the technology of writing the processing instruction information showing the region to be processed and the content of processing in a document to be processed by hand and reading this information by a scanner to specify the region to be processed and the content of processing, thus producing a processing instruction. According to the above technology, documents are sequentially read after the processing instructions are read, and the data described in the processing instructions are calculated from the respective documents, whereby processing such as totalization can be easily realized.

Further, Japanese Patent Laid-Open No. H07-200631 (1995) discloses the technology of in advance writing information for identifying a form at a specific location of a document and recognizing the specific location at the time of reading the document, thereby making it possible to determine the form.

However, the technology described in Japanese Patent Laid-Open No. 2008-145611 cannot be adapted to a case in which a plurality of kinds of documents produced in different forms coexist in the documents (bundle) which are read after the processing instructions are read. More specifically, there is the problem of being unable to determine in which forms the read documents are produced to perform suitable processing.

Further, the technology described in Japanese Patent Laid-Open No. H07-200631 (1995) requires labors and hours since the information of the forms needs to be embedded in all documents in advance, and therefore, is greatly burdensome for users.

Furthermore, in any of the conventional technologies, as more hours are required for the processing of specifying the form of the document, the user feels more inconvenient, and therefore, high-speeding is required in the processing of specifying the form of document.

### SUMMARY OF THE INVENTION

An image processing apparatus according to the present invention comprises, a form registration component configured to register a plurality of document forms; a characteristic amount generation component configured to generate respective characteristic amounts of the plurality of the document forms registered in the form registration component; a representative characteristic amount extraction component configured to extract a difference between the plurality of the document forms as a representative characteristic amount which is used for identifying the forms, by using the generated characteristic amount; a reading component configured to read a document to be checked; and a form determination component configured to determine which document form among the plurality of document forms registered in the form registration component corresponds to the document to be checked that is read by the reading component, by using the representative characteristic amount extracted by the representative characteristic amount extraction component. Alternatively, an image processing apparatus, comprising: a form registration component configured to register a plurality of document forms; a characteristic amount generation component configured to generate respective characteristic amounts of the plurality of the document forms registered in the form registration component; a representative characteristic amount extraction component configured to extract a difference between the plurality of the document forms as a representative characteristic amount which is used for identifying the forms, by using the generated characteristic amount; a storage component configured to store processing instruction information for performing check processing of a described matter of the document form and the representative characteristic amount by associating the processing instruction information with the representative characteristic amount; a reading component configured to read a document to be checked; a form determination component configured to determine which document form among the plurality of the document forms registered in the form registration component corresponds to the document to be checked that is read by the reading component, by using the representative characteristic amount extracted by the representative characteristic amount extraction component; and a check component configured to check an described matter of the document to be checked by using the processing instruction information stored in the storage component by being associated with the document form determined by the form determination component.

According to the present invention, even when documents produced in different forms coexist, it can be determined in which forms the respective documents are produced by simple processing and at a high speed.

Further features of the present invention will become apparent from the following description of exemplary embodiments (with reference to the attached drawings).

### BRIEF DESCRIPTION OF THE DRAWINGS

FIG. 1A is an example of a hardware configuration diagram of a document processing apparatus according to the present invention;

FIG. 1B is an example of a functional block diagram of the document processing apparatus according to the present invention;

FIG. 2 is a flowchart showing a flow from determining a form of a document to performing specific processing corresponding to the form;

FIG. 3 is a flowchart showing the detail of each of form registration processing and processing content registration processing;

FIG. 4 is a flowchart showing the detail of each of characteristic amount generation processing and representative characteristic amount extraction processing;

FIG. 5 is a flowchart showing the detail of form determination processing;

FIG. 6A is a diagram showing an example of a blank document for registering the form of a document;

FIG. 6B is a diagram showing an example of a blank document for registering the form of a document;

FIG. 6C is a diagram showing an example of a blank document for registering the form of a document;

FIG. 7A is a diagram showing an example of region image data divided into regions;

FIG. 7B is a diagram showing an example of region image data divided into regions;

FIG. 7C is a diagram showing an example of region image data divided into regions;

FIG. 8A is a diagram showing an example of a generated characteristic amount;

FIG. 8B is a diagram showing an example of a generated characteristic amount;

FIG. 8C is a diagram showing an example of a generated characteristic amount;

FIG. 9A is a diagram showing an example of a differential characteristic amount;

FIG. 9B is a diagram showing an example of a differential characteristic amount;

FIG. 10A is a diagram showing an example of the differential characteristic amounts;

FIG. 10B is a diagram showing an example of the differential characteristic amounts;

FIG. 11A is a diagram showing an example of the differential characteristic amount;

FIG. 11B is a diagram showing an example of the differential characteristic amount;

FIG. 12A is a diagram showing an example of a representative characteristic amount;

FIG. 12B is a diagram showing an example of a representative characteristic amount;

FIG. 12C is a diagram showing an example of a representative characteristic amount;

FIG. 13A is a diagram showing an example of a narrowed representative characteristic amount;

FIG. 13B is a diagram showing an example of a narrowed representative characteristic amount;

FIG. 13C is a diagram showing an example of a narrowed representative characteristic amount;

FIG. 14A is a diagram showing an example of an extracted document characteristic amount;

FIG. 14B is a diagram showing an example of an extracted document characteristic amount;

FIG. 14C is a diagram showing an example of an extracted document characteristic amount;

FIG. 15A is a diagram showing an example of a scan ticket;

FIG. 15B is a diagram showing an example of a scan ticket;

FIG. 16 is a flowchart showing a flow of processing including processing of producing the scan ticket;

FIG. 17 is a flowchart showing the detail of scan ticket producing processing;

FIG. 18 is a flowchart showing a flow of processing including processing of directly designating the representative characteristic amount;

FIG. 19 is a flowchart showing a flow of processing including processing of changing a representative characteristic amount written in the scan ticket to an arbitrary content;

FIG. 20 is a diagram showing an example of a calculation sequence of similarity;

FIG. 21 is a flowchart showing a flow of processing including processing in the case of reuse of a registered form;

FIG. 22A is an explanatory diagram in the case of performing weighting processing;

FIG. 22B is an explanatory diagram in the case of performing weighting processing; and

FIG. 22C is an explanatory diagram in the case of performing weighting processing.

### DESCRIPTION OF THE EMBODIMENTS

### Embodiment 1

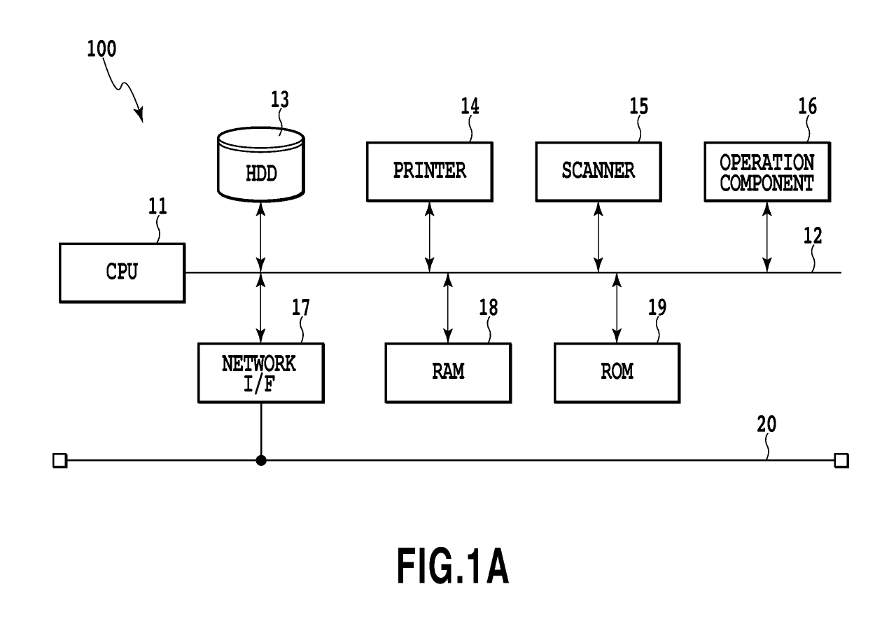

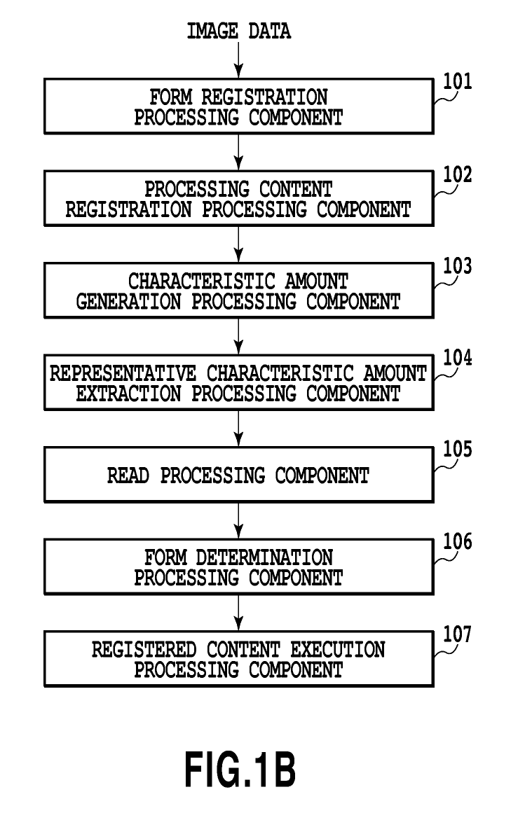

FIG. 1A is an example of a hardware configuration diagram of a document processing apparatus according to the present invention.

A CPU 11 controls an operation of an entire document processing apparatus 100 by loading programs stored in a ROM 19 into a RAM 18. The CPU 11 communicates with each component in the document processing apparatus 100 through a bus 12.

An operation component 16 is a user interface including a plurality of keys for a user to input various instructions and designations, and a display displaying various kinds of information to be reported to the user. A touch panel for inputting an instruction and a designation may be displayed on the display.

A scanner 15 which is a reading apparatus reads a document set on a document table as, for example, a color image, and accumulates electronic data (image data) obtained by this in an HDD 13, the RAM 18 and the like. The scanner 15 may include a document feeding device (not illustrated), which sequentially feeds a plurality of documents set in the document feeding device onto the document table, thus making it possible to read the documents.

The HDD 13 is a hard disk drive including a hard disk, and stores various kinds of information inputted.

A printer 14 which is a printing apparatus prints out an image based on inputted image data onto a recording sheet.

A network I/F 17 connects the document processing apparatus 100 to a network 20, and controls reception of data from an external apparatus on a network and transmission of data to the external apparatus on the network.

In the present embodiment, a case of taking in an image data registered as a form of a document through the scanner 15 will be described as an example. However, an image data of a document sent from an external apparatus may be inputted via the network I/F 17, for example. Further, the present embodiment may be configured by a personal computer (PC) or the like to which the scanner 15 and the printer 19 are connected. In this case, all or a part of the programs which execute the processing which will be described later can be provided to the PC via a network or the like, or can be provided to the PC by being stored in a storage medium such as a CD-ROM.

The procedure, each processing and each processing result in each of the flowcharts described in the following embodiments 1 to 5 are stored in any of the storage components of the RAM 18, the ROM 19 and the HDD 13, and are executed by the CPU 11.

FIG. 1B is an example of a functional block diagram of the document processing apparatus according to the present invention.

A form registration processing component 101 performs processing of registering an image data inputted via the scanner 15 as the form of a document.

A processing content registration processing component 102 performs processing of associating a content of specific processing designated by a user by using the operation component 16 with the form registered by a form registering component and processing of registering the content of specific processing.

A characteristic amount generation processing component 103 performs processing of generating a characteristic amount of a form.

A representative characteristic amount extraction processing component 104 performs processing of comparing the characteristic amount of each form generated by the characteristic amount generation processing component 103, and extracting a representative characteristic amount for identifying the form for each form.

A read processing component 105 performs processing of reading a set document or the like by the scanner 15.

A form determination processing component 106 performs processing of determining the forms of the individual documents by using the representative characteristic amount extracted by the representative characteristic amount extraction processing component 104 for the documents (bundle) read by the read processing component 105.

A registered content execution processing component 107 executes specific processing associated with the form determined by the form determination processing component 106 for the documents read by the read processing component 105.

The document determining apparatus according to the present invention is configured by the form registration processing component 101, the characteristic amount generation processing component 103, the representative characteristic amount extraction processing component 104, the document read processing component 105 and the form determination processing component 106, out of the above described respective processing components.

First, an outline of the operation of the document processing apparatus 100 according to the present invention will be described.

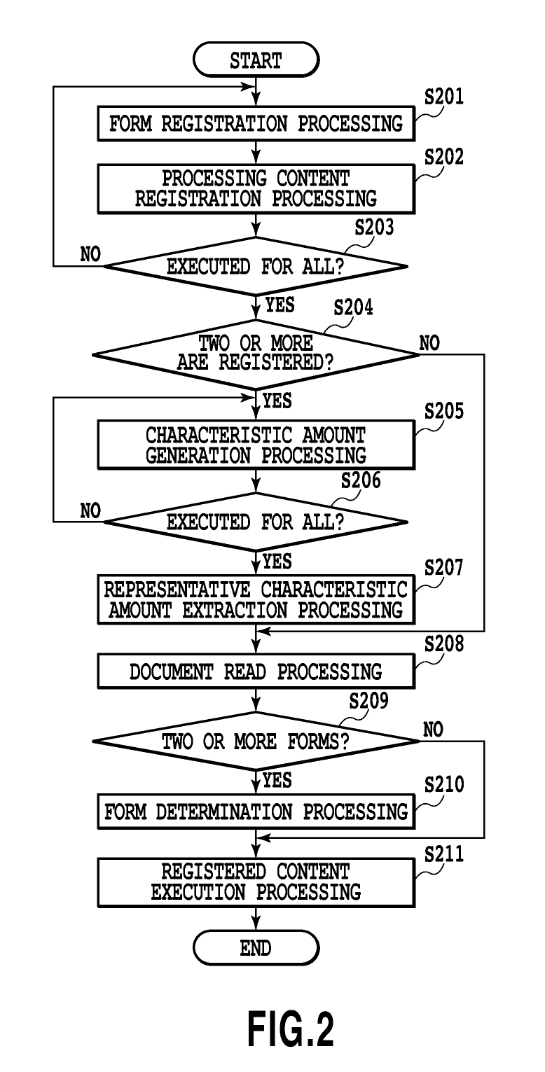

FIG. 2 is a flowchart showing a flow from determining the form of a document to performing specific processing corresponding to the form.

First, in step 201, the form registration processing component 101 registers an image data inputted via the scanner 15 as the form of a document.

Next, in step 202, the processing content registration processing component 102 registers the content of the specific processing designated by a user via the operation component 16 or the like by associating the content with the form registered in step 201.

Step 201 and step 202 are performed times as many as the number of forms of documents to be registered. When there are three forms of documents to be registered, step 201 and step 202 are repeated by three times. In step 203, it is determined whether the form registration processing (S201) and the processing content registration processing (S202) are performed for the forms of all documents.

When the form registration processing (S201) and the processing content registration processing (S202) are determined to be performed for all the forms, it is determined whether two or more forms are simultaneously registered in step 204. When there are two or more forms, the characteristic amount generation processing component 103 generates a characteristic amount indicating a difference from the other forms for each form, in step 205. When one form is registered, the process proceeds to step 208 without performing the characteristic amount generation processing and the representative characteristic amount extraction processing (step 205 to step 207).

In step 206, it is determined whether the characteristic amounts are generated with respect to all the forms. When it is determined that the characteristic amounts are generated for all the forms, the process proceeds to step 207.

In step 207, the representative characteristic amount extraction processing component 104 extracts a representative characteristic amount which enables discrimination of the form based on the generated characteristic amount. The representative characteristic amount is a characteristic amount which enables discrimination from the other document form simultaneously registered, and is extracted for each form.

After the representative characteristic amount extraction processing is performed, in step 208 the document read processing component 105 instructs the scanner 15 to read documents, and reads the documents (bundle) to be the target of the specific processing registered in step 202.

When documents of a plurality of forms coexist in the documents (bundle) and for executing the specific processing to the read documents (S209), the document forms need to be specified, the process proceeds to step 210. Meanwhile, when the documents (bundle) are constituted of documents of one kind of form and the form of the read documents is obvious, the process proceeds to step 211 without performing form determination processing (S210).

In step 210, the form determination processing component 106 determines the forms of the read documents by using the extracted representative characteristic amounts.

Finally, in step 211, the registered content execution processing component 107 executes the specific processing associated with one determined form for the corresponding document.

Hereinafter, each processing described above will be described by using the flowcharts showing the processing in more detail.

### (Form Registration Processing and Processing Content Registration Processing)

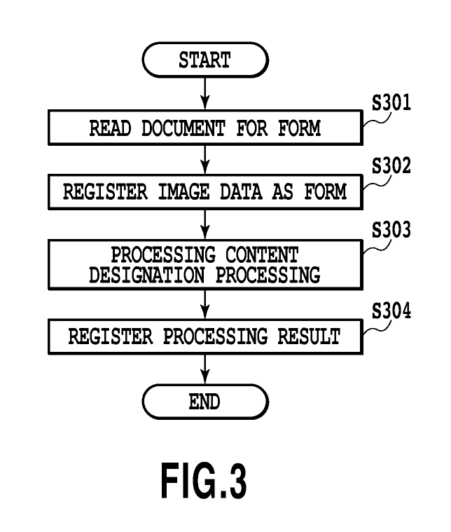

FIG. 3 is a flowchart showing the details of the contents of the form registration processing (S201) and the processing content registration processing (S202).

First, in step 301, the form registration processing component 101 reads the document set for form registration with the scanner 15 to obtain the image data of the document.

Subsequently, in step 302, the form registration processing component 101 stores the obtained image data in the storage component (HDD 13 or the like) and registers the image data as the form of the document.

Subsequently, in step 303, the processing content registration processing component 102 receives the content of the specific processing to be executed by the registered content execution processing component 107 from the user via the operation component 16, and registers the content by associating the content with the form registered in step 302. The content to be registered is matters such as what processing is to be performed for the document produced in the form, and for which portion (region) on the document the processing is performed, and the user arbitrarily determines the matter. As the specific processing, the processing of confirming the presence or absence of the description of, for example, affixation of a seal, a signature, an address, a date, an amount of money and the like is conceivable.

Next, in step 304, the processing content registration processing component 102 registers a dealing method of the processing result of the above described specific processing. A user instructs the dealing method via the operation component 16. As the dealing method, for example, the contents are conceivable, such as displaying the processing result on the display of the operation component 16, or instead of this (or in addition to this), reporting the processing result to a predetermined mail address registered in advance by mail. Further, the display mode of the processing result (for example, the format of a list which shows the result at a glance, and the like) may be also registered in combination.

As the document for form registration in step 301, a blank document without describing an address, an amount of money and the like is usually used. However, the document for form registration does not have to be necessarily a blank document, if only the difference from the other forms can be recognized. For example, an arbitrary one of the document bundle in which addresses, the amounts of money and the like are actually written may be used.

The above processing is executed for each form.

### (Characteristic Amount Generation Processing and Representative Characteristic Amount Extraction Processing)

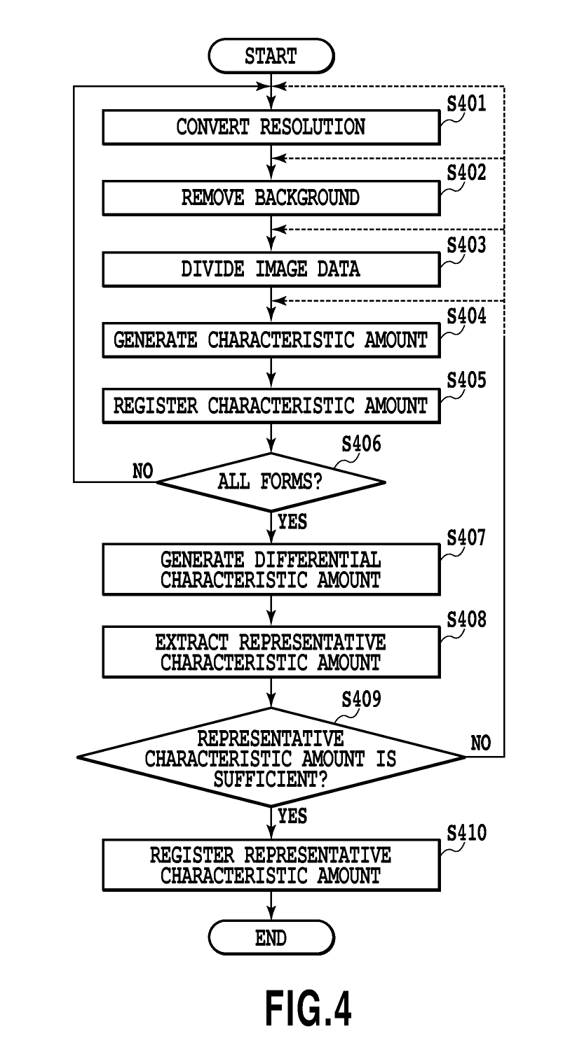

FIG. 4 is a flowchart showing the details of the contents of the characteristic amount generation processing (S205) and the representative characteristic amount extraction processing (S207). Step 401 to step 406 correspond to the characteristic amount generation processing, and step 407 to step 410 correspond to the representative characteristic amount extraction processing.

First, in step 401, the characteristic amount generation processing component 103 performs processing of converting resolution for the image data registered as the form in the form registration processing (S203). For example, the resolution of the image data is converted into 100 dpi from 600 dpi to reduce the information amount of the image data. In the resolution conversion processing, conversion accompanied by the filter processing effect may be simultaneously performed.

Next, in step 402, the characteristic amount generation processing component 103 performs processing of removing background for the image data whose resolution is converted. By the background removal processing, excessive information is deleted. In concrete, processing of setting a value of the image whose value is 128 or more among eight-bit data of RGB to 255 is performed.

Subsequently, in step 403, the characteristic amount generation processing component 103 divides the image data subjected to the background removal processing into the regions each of which has an optional size, for example, an image size of 256 by 256 pixels, a size of the integer multiple of it, or the like. Thus, the image data according to each region (hereinafter, called a region image) is obtained. The size at the time of division is desirably set at a size larger than a misregistration amount which can occur at the time of the reading by the scanner 15. Thereby, the processing time in step 404 and the following steps can be shortened, and the characteristic amount which can be adapted to possible occurrence of misregistration can be generated.

Subsequently, in step 404, the characteristic amount generation processing component 103 generates a characteristic amount for each region image obtained by the region division processing. In this case, “characteristic amount” is the information showing the characteristics of the form of a document, and is configured by characteristic information and positional information. The characteristic information is an index which is quantitatively or qualitatively comparable, and includes, for example, pixel information such as luminance and brightness, character information subjected to OCR processing, color information, a histogram, and attribute information such as a halftone dot and a font. In the present embodiment, the number of pixels with the pixel value of luminance of zero is adopted as the characteristic information. For the purpose of enhancement in precision of form determination or the like, the characteristic information may be an arbitrary combination such as the number of pixels with the pixel value of luminance density of zero and OCR character information. What content is assigned to the characteristic information is in advance registered by a user.

The positional information is the information showing the positions of the individual region images, which are obtained by the region division processing (S403), on the document, and this information gives the understanding on which portions on the document the region images are located in.

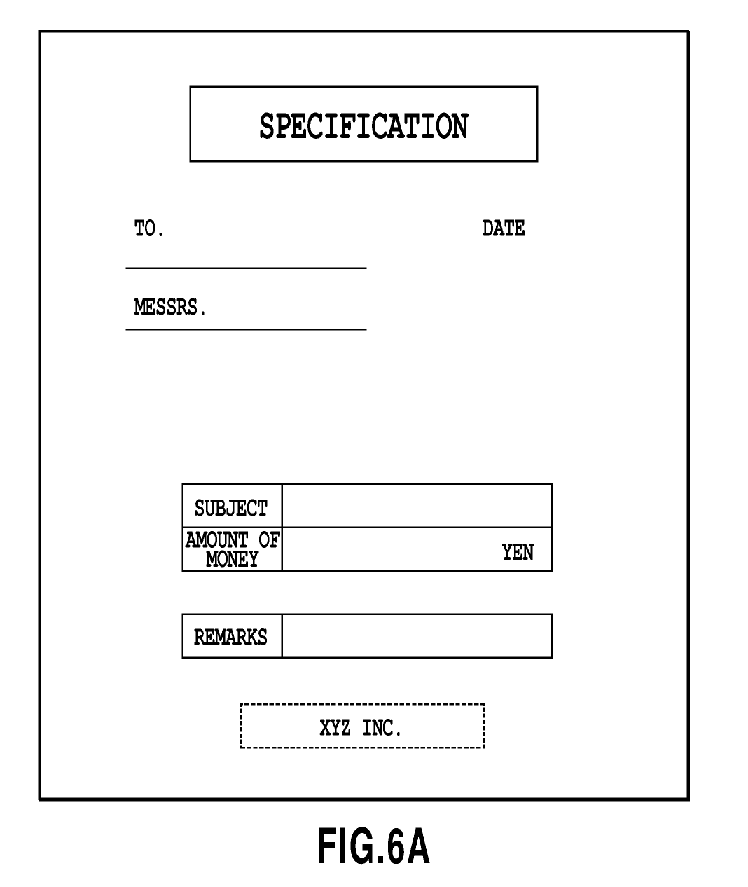

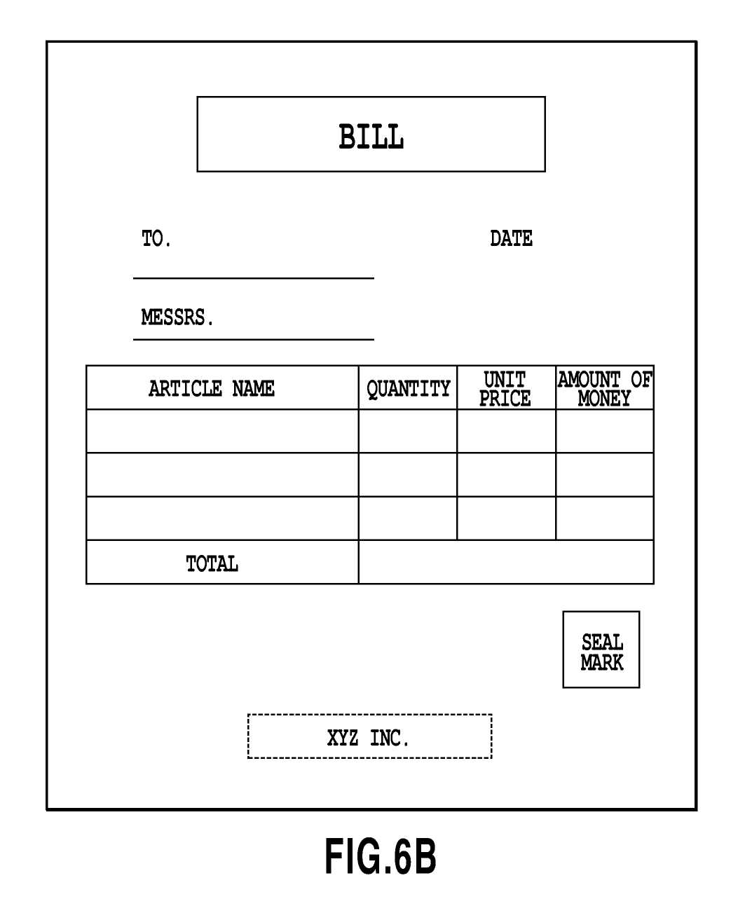

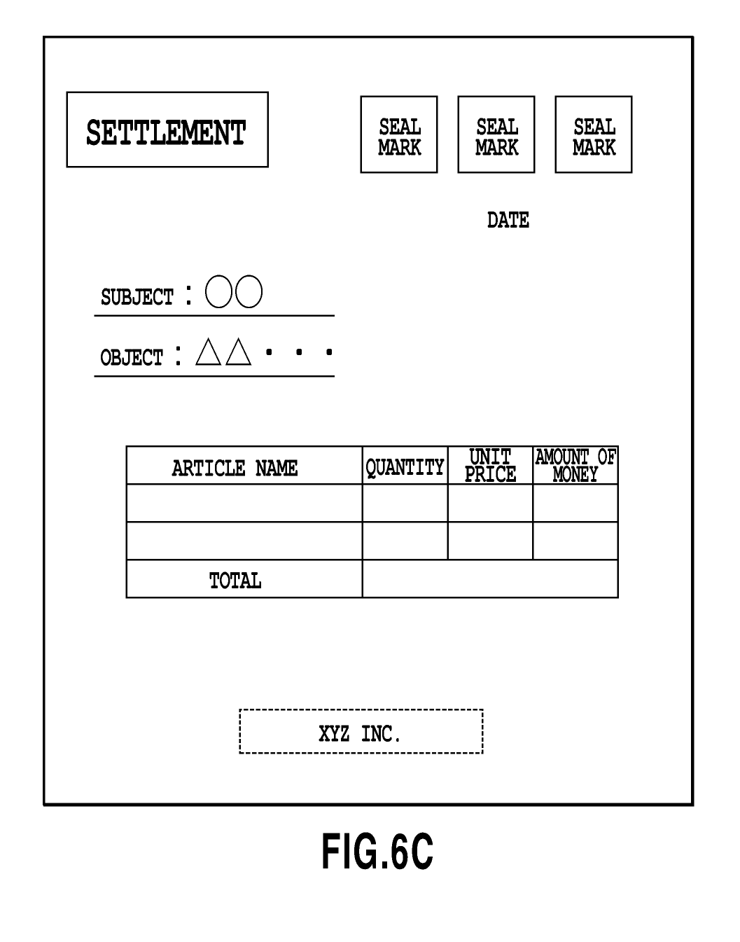

The processing up to now will be described by using the concrete examples shown in FIGS. 6A to 6C. In this case, FIGS. 6A to 6C are examples each showing a blank document for registering a form of a document. FIG. 6A is a blank document of “specification”, FIG. 6B is that of “bill”, and FIG. 6C is that of “settlement”.

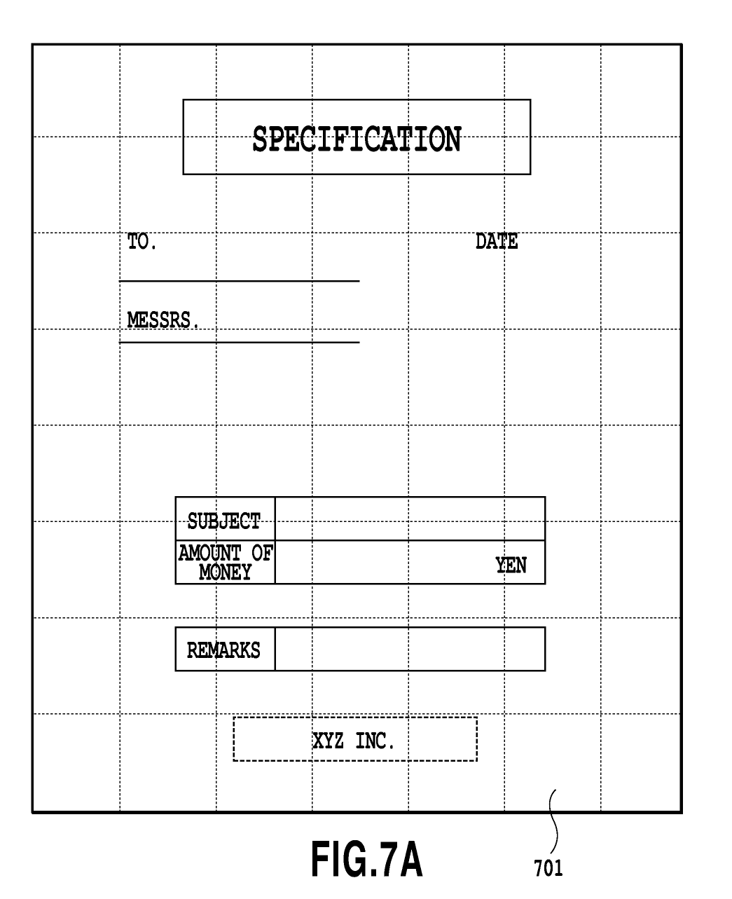

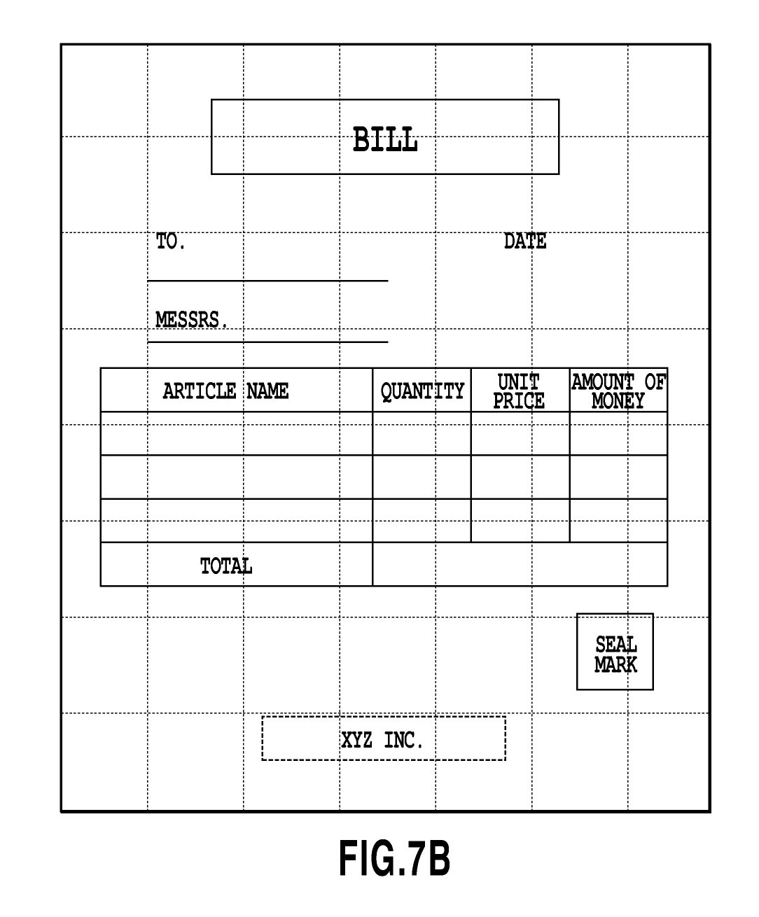

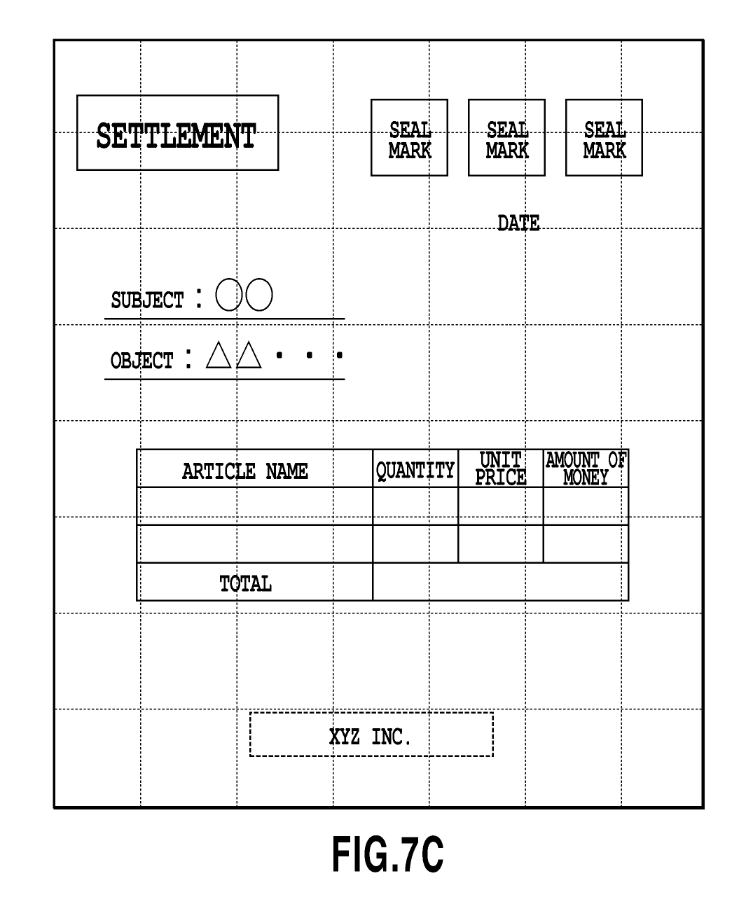

First, the resolution conversion processing of step 401 and the background removal processing of step 402 are performed for each of the image data of the three kinds of blank documents read by the scanner 15. Thereafter, in step 403, the region division processing is performed to obtain the region images as shown in FIGS. 7A to 7C. In the example of FIG. 7A, the image is divided into 56 regions in total with the size of one region of 256 by 256 pixels, and reference numeral 701 shows one of the divided regions.

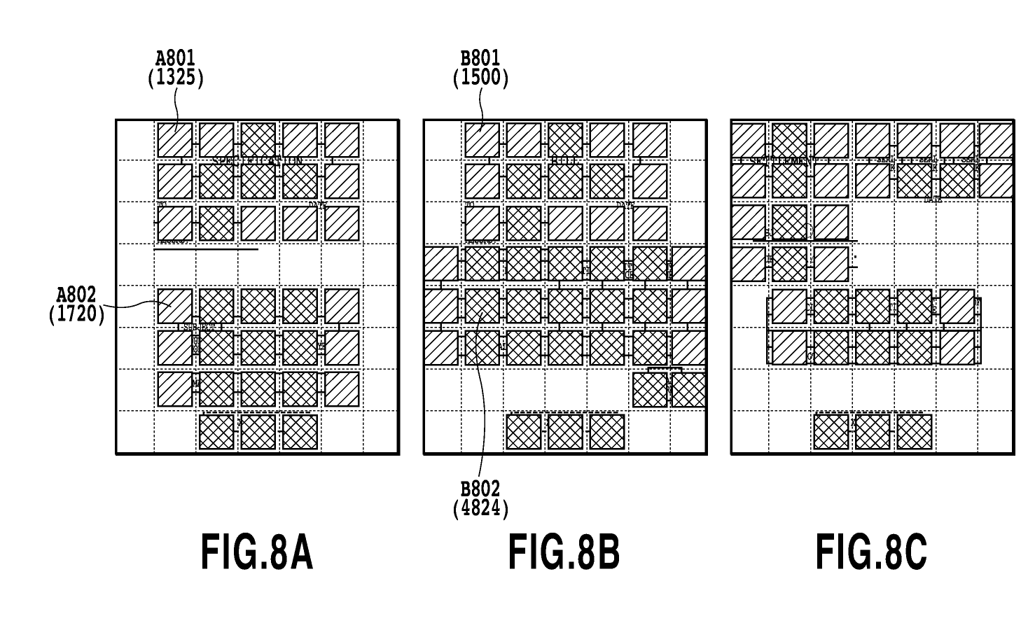

Subsequently, in step 404, the characteristic amount for each region image is generated. FIGS. 8A to 8C respectively show the region of the generate characteristic amount for each form. In this case, the regions with the number of pixels as the characteristic information of zero (more specifically, the number of pixels whose luminance pixel values are zero is zero) are shown by blank, and the regions other than blank, namely, the regions expressed by the oblique lines and the regions shown by the mesh are the regions where significant characteristic amounts are generated. For example, the number of pixels as the characteristic information of the region shown by A801 is 1325. Similarly, that of the region shown by A802 is 1720, that of the region shown by B801 is 1500, and that of the region shown by B802 is 4824. The positional information is expressed by the coordinate information expressing the upper left and the lower right among the vertexes of the square forming the region, for example. The characteristic information and the positional information are combined to form the characteristic amount.

In the above described FIGS. 8A to 8C, the region expressed by the oblique lines is the region with the number of pixels as the characteristic information of less than 2000, and the region expressed by the mesh is the region with the number of pixels as the characteristic information of 2000 or more. The significance of such classification will be described later.

In step 405, the characteristic amount generation processing component 103 associates the generated characteristic amounts with the respective forms, and registers them into the storage component (HDD 13 or the like).

Each processing is repeated until the characteristic amounts are obtained for all the registered forms (step 406), and when the characteristic amount registration processing (S405) is finished for all the forms, the process proceeds to step 407.

In step 407, the representative characteristic amount extraction processing component 104 extracts the difference (hereinafter, called a differential characteristic amount) between the forms based on the generated characteristic amounts. In the case of the present embodiment, the three forms of “specification”, “bill” and “settlement” are registered. Accordingly, the combination of the forms from which the differential amount is extracted is composed of three patterns including the form of “specification” and the form of “bill”, the form of “specification” and the form of “settlement”, and the form of “bill” and the form of “settlement”. For example, in the case of “specification”, the differential characteristic amount from “specification” and the differential characteristic amount from “settlement” are respectively calculated.

Next, in step 408, the representative characteristic amount extraction processing component 104 extracts a representative characteristic amount by using the differential characteristic amount calculated in step 407. In concrete, the representative characteristic amount is extracted by extracting the differential characteristic amount common to all the differential characteristic amounts extracted with respect to one form by form unit. The representative characteristic amount thus extracted shows the characteristic portion which is not present in the other forms, and therefore, makes it possible to identify the form uniquely in relation with the other registered forms.

Subsequently, in step 409, it is determined whether the extracted representative characteristic amount is sufficient. For example, when the number of regions having the representative characteristic amount is smaller than a predetermined number, or when the extracted characteristic information itself does not reach a fixed level, the representative characteristic amount is determined as insufficient, and the process returns to any one of steps 401 to 404 to calculate the representative characteristic amount again. In this case, a user determines and registers in advance the criterion at the time of determining whether or not the representative characteristic amount is sufficient, and which step to return when it is determined as insufficient. In the step to which the process returns, the characteristic amounts are again obtained by changing the conversion rate of the resolution (S401), the background removal rate (S402), the division size (S403) and the like, and the characteristic amounts are recalculated by changing the content of the characteristic information. When the characteristic amounts are generated again, the characteristic amounts are updated in step 405, and calculation of the differential characteristic amount (S407) and extraction of the representative characteristic amount (S408) are performed again based on the updated characteristic amounts. In step 409, when the extracted representative characteristic amount is determined as sufficient, the process goes to step 410.

When the representative characteristic amount is determined as insufficient in step 409, the user may directly designate the characteristic information and the positional information as the representative characteristic amount as will be described in embodiment 3, instead of returning to any one of step 401 to step 404. Further, the representative characteristic amount may be controlled to be extracted from the region in which the user does not write, for the document to be checked corresponding to the form of a document. For example, in the case of the form of “specification”, the column of “amount of money” in which the user will write may be controlled not to be extracted as the representative characteristic amount. This is because the representative characteristic amount is not the region which should be changed by the write of the user.

In step 410, the representative characteristic amount extraction processing component 104 registers the representative characteristic amount extracted in step 408 by associating the representative characteristic amount with the corresponding form, for each form.

The processing from step 407 to step 410 will be described in detail based on the previous concrete example.

When the forms are registered based on the three kinds of blank documents shown in FIGS. 6A to 6C, three sets of differential characteristic amounts are obtained in total in the differential characteristic amount generation processing in step 407.

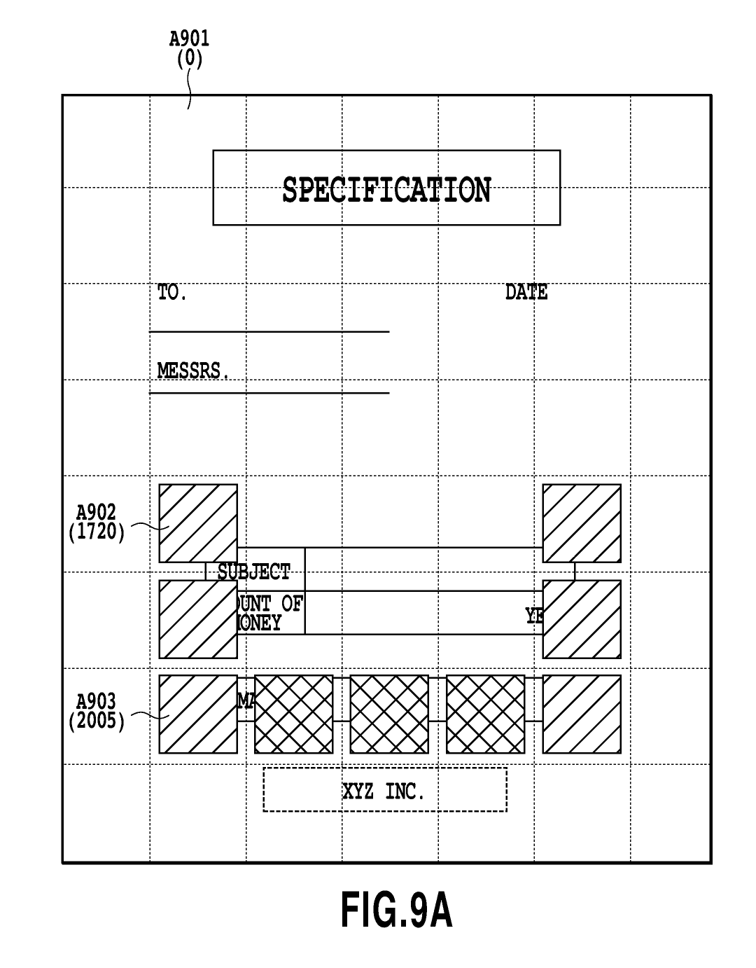

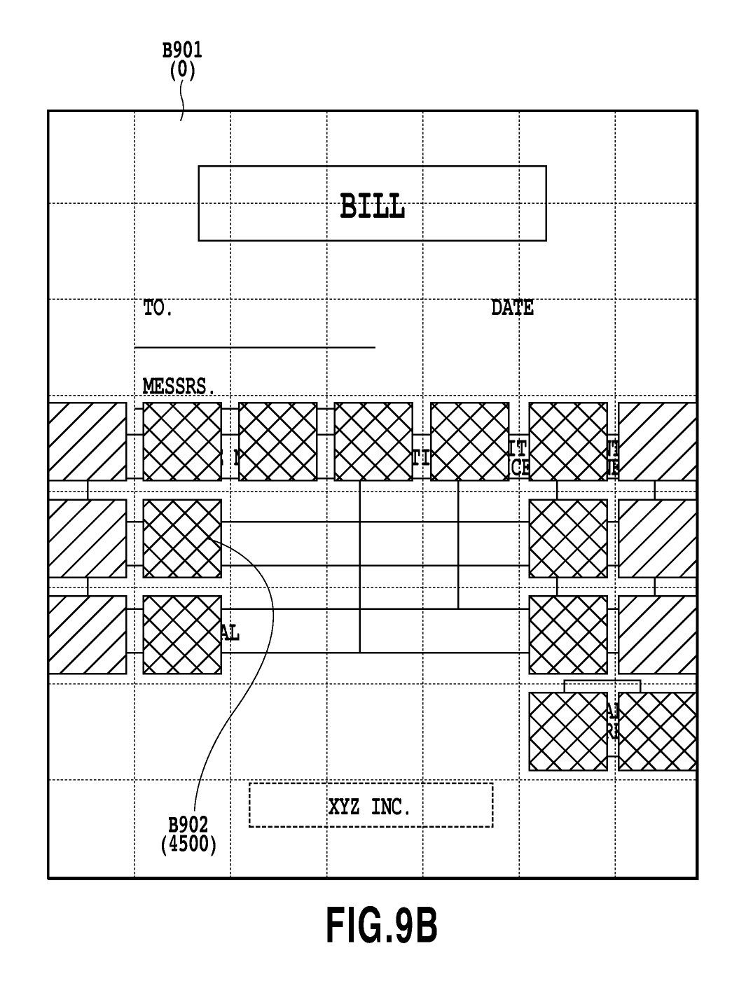

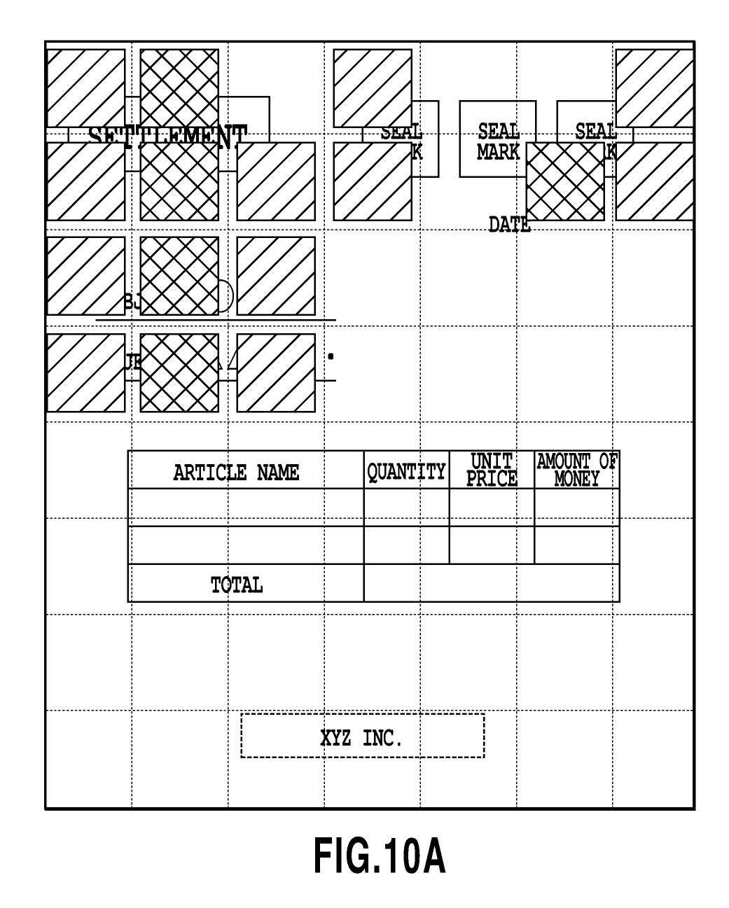

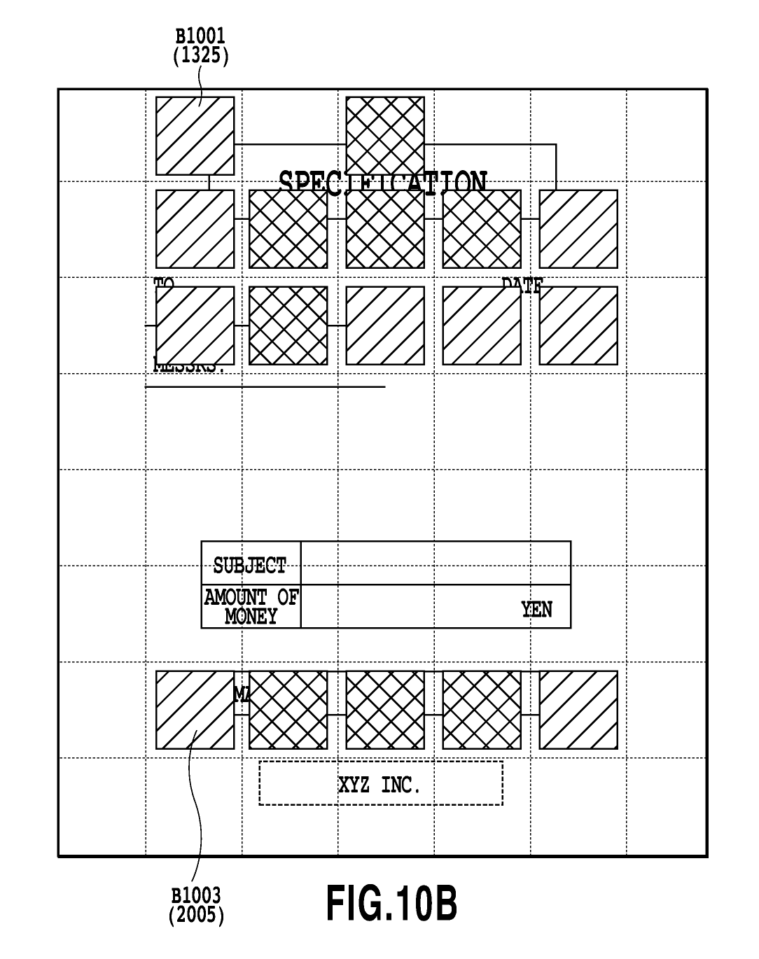

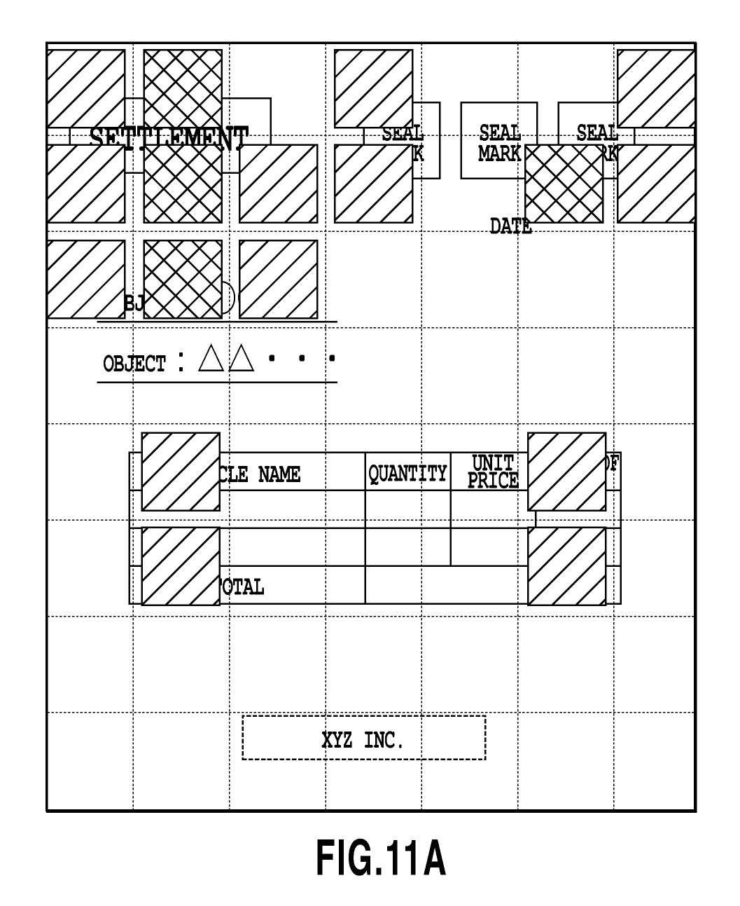

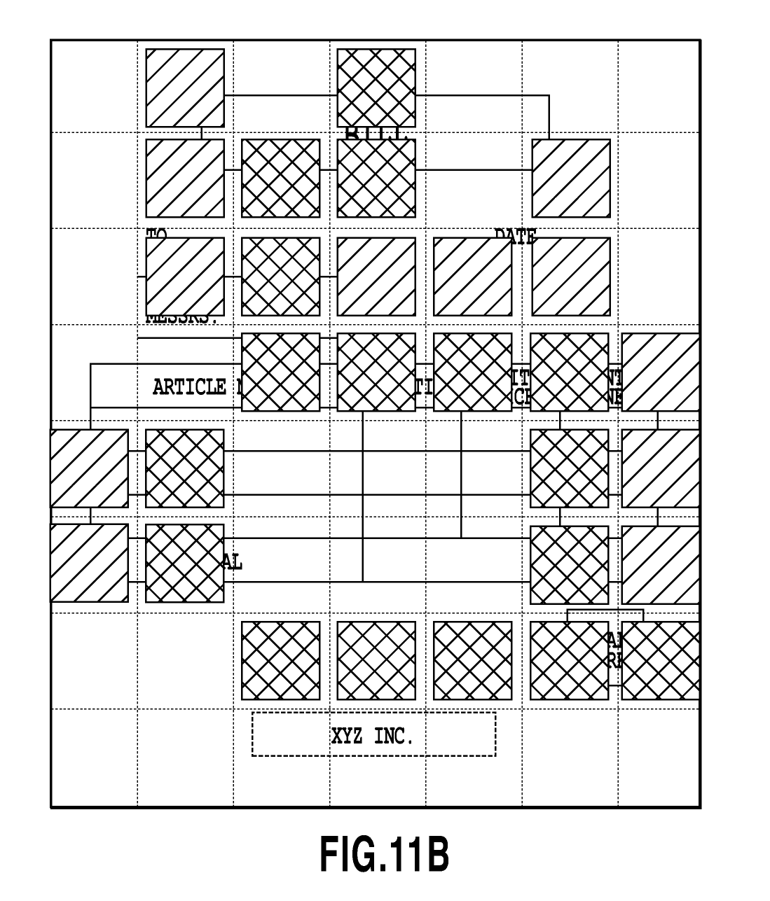

First, by comparing the characteristic amount of “specification” (FIG. 8A) and the characteristic amount of “bill” (FIG. 8B), the differential characteristic amount between “specification and bill” as shown in FIGS. 9A and 9B is obtained. FIG. 9A shows the characteristic amount which is present in “specification”, but is absent in “bill”. FIG. 9B shows the characteristic amount which is present in “bill”, but is absent in “specification”. Similarly, by comparing the characteristic amount of “specification” (FIG. 8A) and the characteristic amount of “settlement” (FIG. 8C), the differential characteristic amount between “specification and settlement” as shown in FIGS. 10A and 10B is obtained. Further, by comparing the characteristic amount of “bill” (FIG. 8B) and the characteristic amount of “settlement” (FIG. 8C), the differential characteristic amount between “specification and settlement” as shown in FIGS. 11A and 11B is obtained.

Here, more concrete description will be made with reference to the case of obtaining the differential characteristic amount between “specification and bill” cited as an example.

First, between the corresponding regions of the forms to be compared, the characteristic information (in the case of the present embodiment, the number of pixels with the pixel value of the luminance in the specific region being zero) is compared, and the difference between both is obtained. The obtained difference is applied to the following relational expression.

When the relation of “difference (number of pixels)÷total number of pixels in region<threshold value set in advance” is satisfied, the characteristic information of both the regions is determined as equal, and the characteristic amount of the region is not a differential characteristic amount. Meanwhile, when the relation of “difference (number of pixels)÷total number of pixels in region≧threshold value set in advance” is satisfied, the characteristic information of both the regions is determined as different, and the characteristic amount of the region is the differential characteristic amount.

Now that A801 of FIG. 8A has the number of pixels as the characteristic information of 1325 and B801 of FIG. 8B has that of 1500, the difference (number of pixels) between both of them is 775. When the values are applied into the above described relational expression with the threshold value set in advance as 2%,

775÷(256×256)≈0.2

is obtained, and this is found to be smaller than 2% that is a threshold value. In this case, the characteristic amounts of both of them are determined as substantially equal, and the regions are expressed as blank regions which do not have a differential characteristic amount as shown in A901 and B901 of FIGS. 9A and 9B.

Similarly, when A802 of FIG. 8A having the number of pixels as the characteristic information of 1720 and B802 of FIG. 8B having that of 4824 are seen, the difference is 3104, and therefore,

3104÷(256×256)≈4.7%

is obtained. This is larger than 2%, and therefore, 1720 is the differential characteristic amount for A802, and 4824 is the differential characteristic amount for B802. As shown in A902 of FIGS. 9A and B902 of FIG. 9B, they are expressed as the regions having the differential characteristic amounts (regions other than blank).

Such processing is performed in the combinations of all the registered forms, and the differential characteristic amounts are generated.

Next, based on the differential characteristic amount generated as described above, the representative characteristic amount of each form is calculated in the representative characteristic amount extraction processing (S408). However, when two forms are registered, the differential characteristic amount can directly become the representative characteristic amount, and therefore, the processing of step 408 can be omitted.

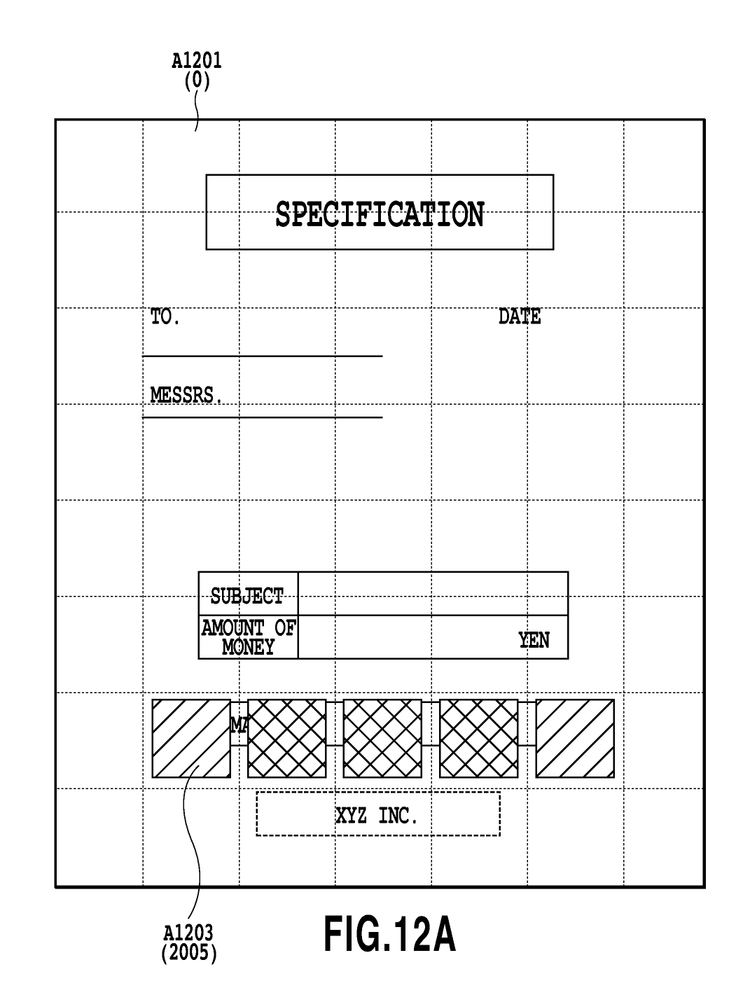

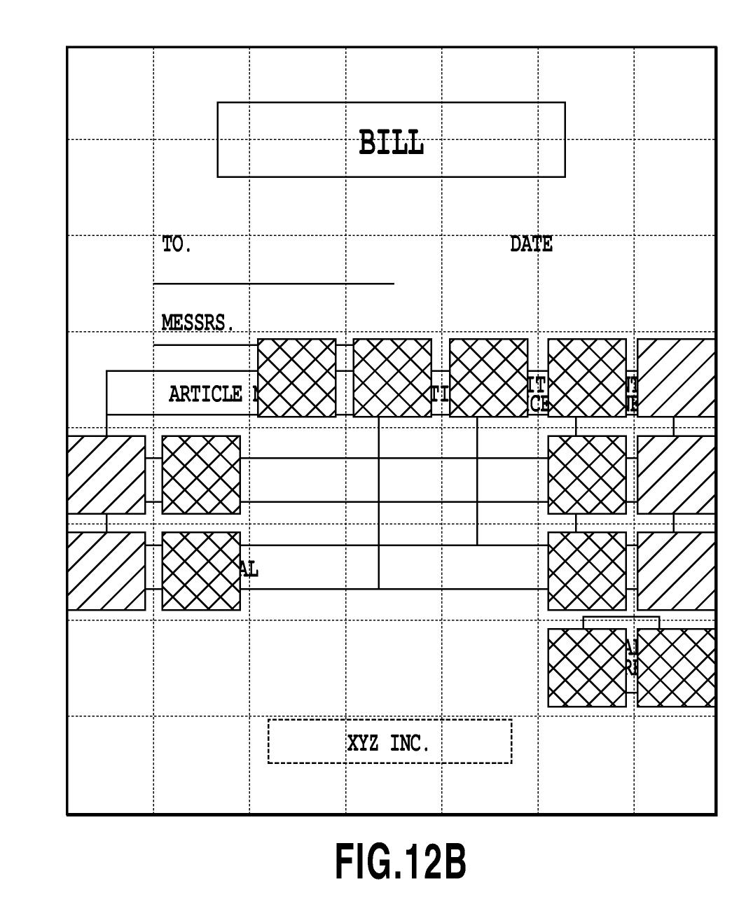

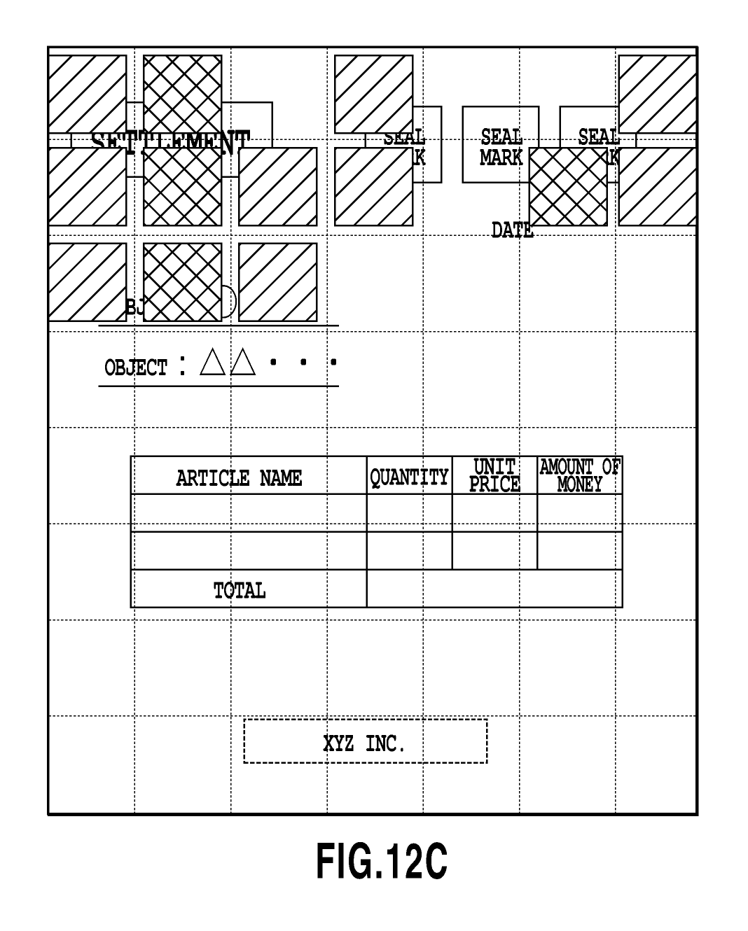

For example, in regard with “specification”, the respective differential characteristic amounts are calculated as FIG. 9A as the differential characteristic amount from “bill”, and FIG. 10B as the differential characteristic amount from “settlement”. In this case, the locations where the regions expressing the differential characteristic amount are common in both FIG. 9A and FIG. 10B are the regions expressing the representative characteristic amount for uniquely identifying “specification”. The portion constituted of the two regions expressed by the oblique lines and the three regions expressed by the meshes as shown in FIG. 12A is extracted as the representative characteristic amount of “specification”. Similarly, the representative characteristic amount of “bill” and the representative characteristic amount of “settlement” are respectively extracted as shown in FIG. 12B and FIG. 12C.

The concrete method for specifying the locations where the differential characteristic amounts are commonly present will be described with reference to the case of “specification” as an example. First, in 81001 of FIG. 10B, the differential characteristic amount with the number of pixels as the characteristic information of 1325 is present, but the number of pixels as the characteristic information in the corresponding A901 of (a) is zero. In this case, the regions expressing the differential characteristic amounts cannot be defined as common, and therefore, the region is not a region configuring the representative characteristic amount of “specification”. Accordingly, the region is expressed by a blank as shown in A1201 of FIG. 12A. Meanwhile, in B1003 of FIG. 10B, the differential characteristic amount with the number of pixels as the characteristic information of 2005 is present, and in the corresponding A903 of FIG. 9A, the differential characteristic amount with the number of pixels as the characteristic information of 2005 is also present. In this case, the regions expressing the differential characteristic amount can be defined as commonly present, and therefore, the region is a region configuring the representative characteristic amount of “specification”. Accordingly, the region with the number of pixels as the characteristic information of 2005 is extracted as the region with the representative characteristic amount as shown in A1203 of FIG. 12A.

In this case, even when the numbers of pixels as the characteristic information do not correspond to each other, if the difference between both of them is within a certain fixed range (for example, within 10%), the difference may be dealt as an allowable error, and the regions expressing the differential characteristic amounts may be determined as common.

Such processing is performed for all the regions in which differential characteristic amounts are present, and the representative characteristic amount as shown in FIG. 12A is finally obtained in regard with “specification”. Further, the similar processing is performed for “bill” and “settlement”, and the representative characteristic amounts as shown in FIG. 12B and FIG. 12C are respectively obtained.

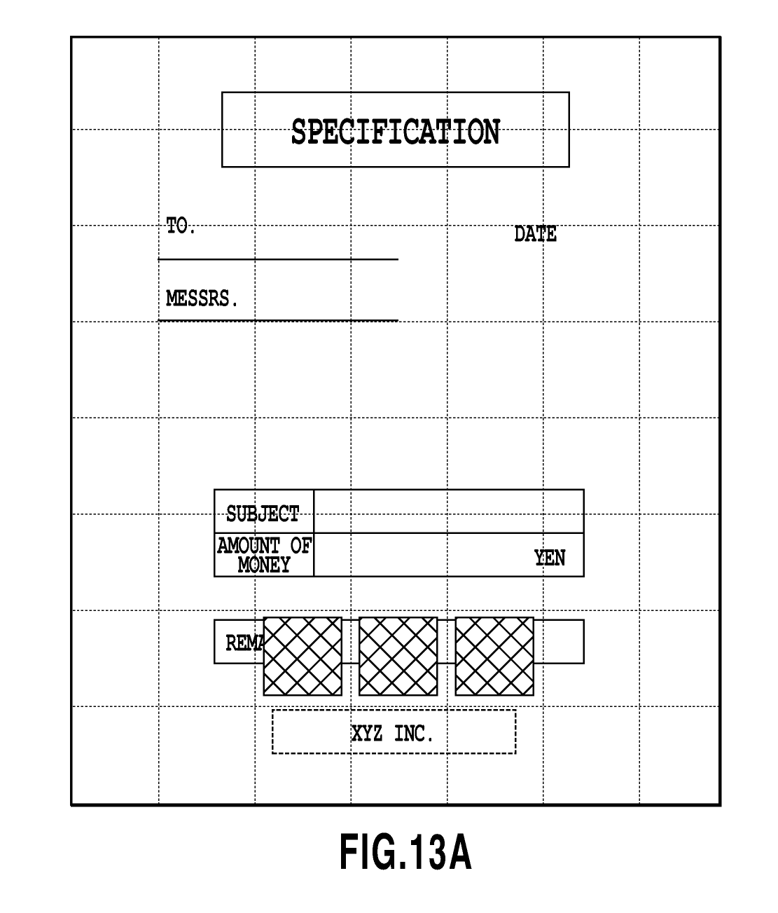

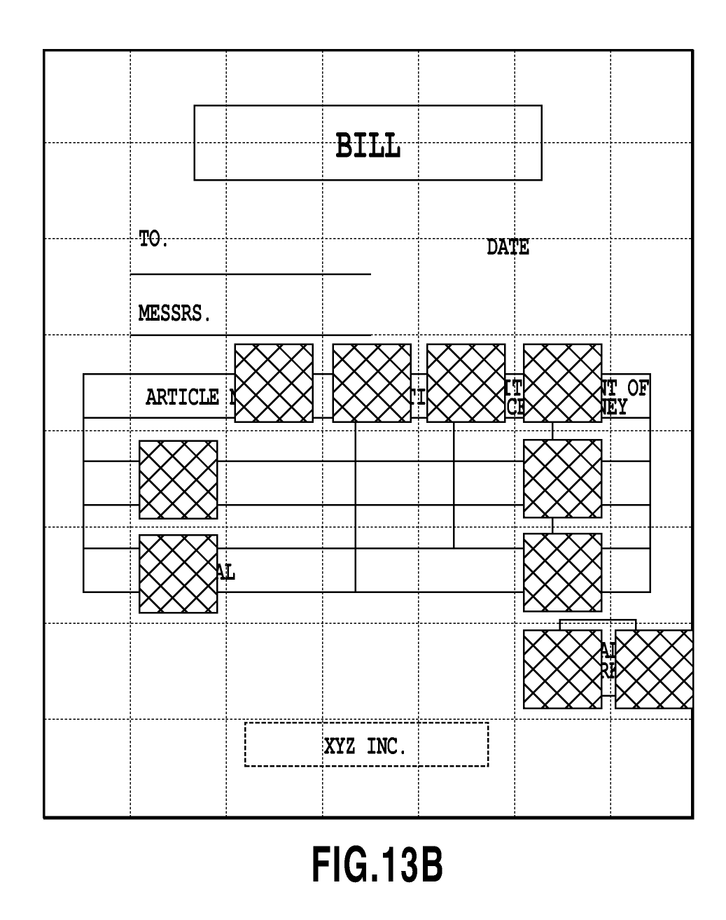

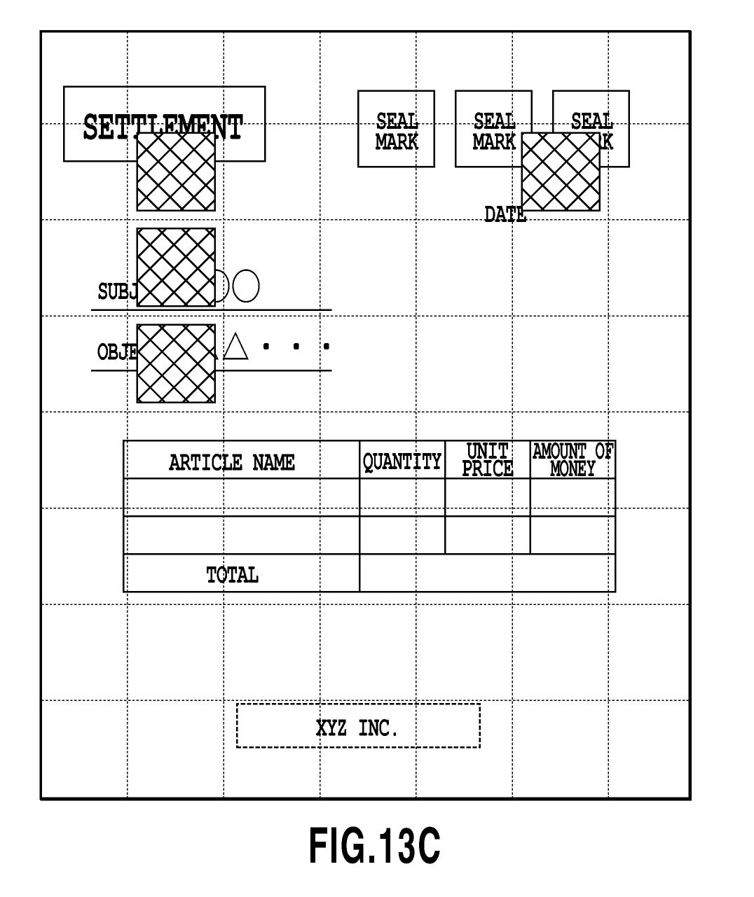

The representative characteristic amount obtained as described above may be further narrowed down. Classifying the regions having the characteristic amounts into two kinds of the oblique line and mesh as the additional processing in the previous step 404 is exploited in the narrowing processing. More specifically, it is used as the criterion at the time of narrowing that the regions configuring the representative characteristic amounts are classified into two. In concrete, for example in the case of “settlement”, the representative characteristic amount is constituted of 13 regions in total that are the nine regions expressed by the oblique lines, and the four regions expressed by meshes, as shown in FIG. 12C. Here, the processing of deleting all the regions expressed by the oblique lines, and leaving only the regions expressed by the meshes is performed. Thereby, the representative characteristic amount of “settlement” is narrowed down to only the region expressed by the meshes as shown in FIG. 13C. FIG. 13C shows the result of performing the similar processing for “bill”. By narrowing down the regions configuring the representative characteristic amount, the information amount of all the representative characteristic amounts is reduced, and processing burden in the form determination processing (S210) can be reduced.

When classification of the regions having the characteristic amounts is additionally performed in step 404, the number of classifications is not limited to two, and may be three or four. Further, in the above described example, the regions expressed by the oblique lines are deleted, and the regions expressed by the meshes are left, but the opposite may be adopted. The presence or absence and content of the additional processing and the criterion of narrowing can be arbitrarily determined in consideration of precision in the form determination processing of the representative characteristic amount after narrowing, the property of the characteristic information and the like.

By performing the characteristic amount generation processing (S205) and the representative characteristic amount extraction processing (S207) as described above, the representative characteristic amount of each form is extracted.

In the above described characteristic amount generation processing, weighting processing may be performed for the calculated characteristic information by using the characteristic information of the peripheral regions. Characteristic information T in this case is calculated based on the following formula by using the characteristic information of the peripheral eight regions surrounding the region of attention desired to be obtained.

$$T = {\sum }_{i = 1}^{9} {W}_{i} {t}_{i} \\ Here , {\sum }_{i = 1}^{9} {W}_{i} = 1 \qquad [ Expression 1 ]$$

ti: characteristic information of each region i, wi: weight applied to each region i.

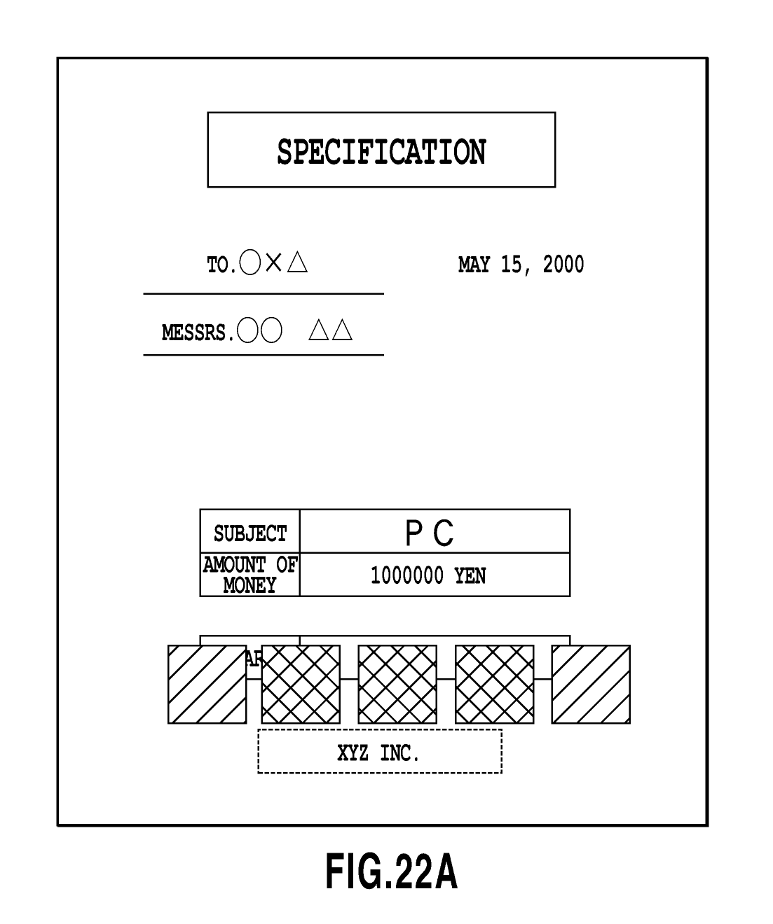

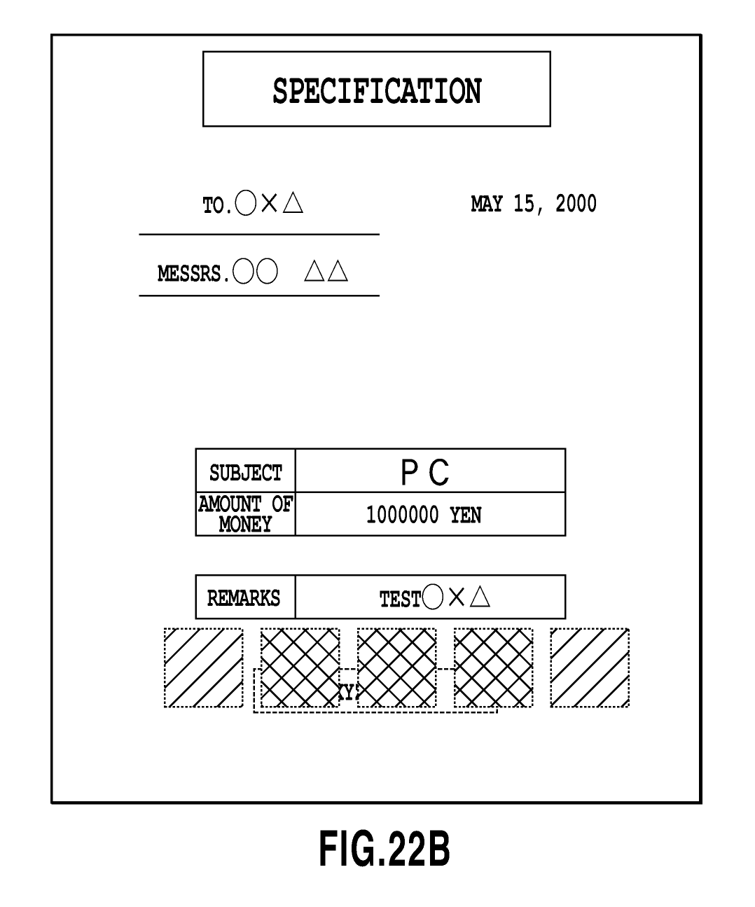

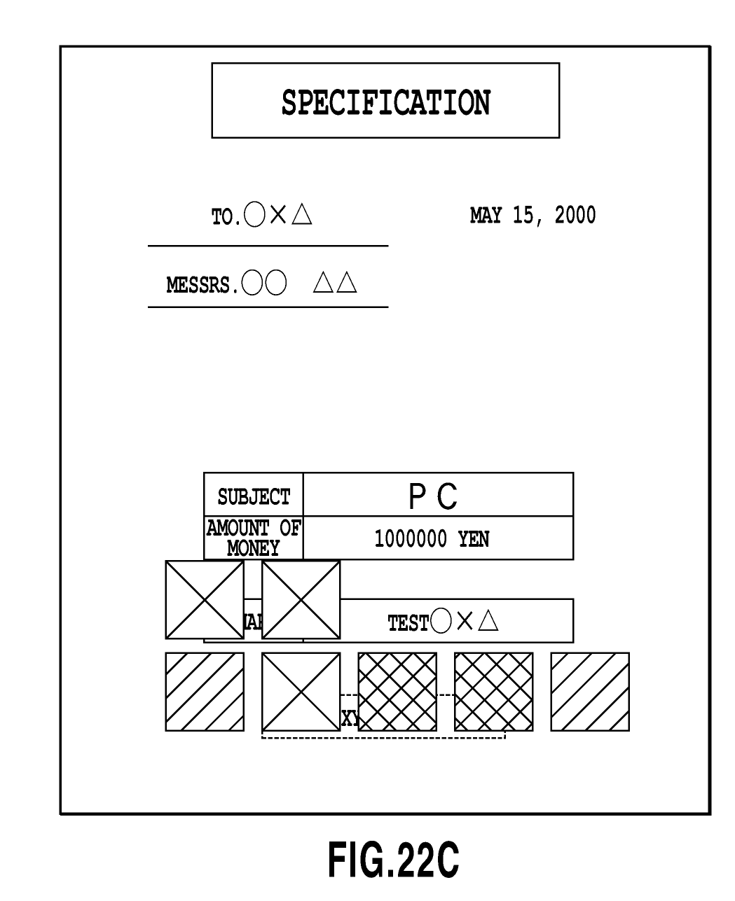

FIGS. 22A to 22C are explanatory diagrams of the case of performing weighting processing with the form of “specification” as an example. As described above, in the case of “specification”, the image data and the representative characteristic amount as shown in FIG. 22A are ideally obtained. However, it is conceivable that they cannot be ideally obtained due to misregistration at the time of reading, and a defect of the form registration document itself. FIG. 22B shows the state in which the image data after reading is misaligned in the vertical direction, and the remarks column which should be normally covered with the representative characteristic amount is not covered with the representative characteristic amount. Especially for the regions (regions at both ends) shown by the oblique lines, only the blank space is covered. Therefore, as it is, the characteristic amounts for the regions at both ends become zero, and an extremely improper representative characteristic amount is extracted.

Weighting enables generation of the characteristic amount effective to some degree in such a case. FIG. 22C shows the state of performing weighting processing for the image data of “specification” misaligned in the vertical direction. The regions shown by the crosses show three regions (directly above, upper right, and right side) of the peripheral eight regions of the oblique line region at the left end. Among these three peripheral regions, the regions directly above and at the upper right cover the remarks column, and the region at the right side covers the company name column. Accordingly, from these three peripheral regions, some characteristic amount is extracted. Therefore, by the above described formula, some characteristic amount is calculated for the region shown by the oblique line at the left end. If weighting using the characteristic amount of the peripheral region is performed with the possibility of occurrence of misregistration to the read image data taken into consideration, the characteristic amount compensating misregistration of the positional relationship to some degree can be calculated, and the representative characteristic amount adaptable to misregistration to some degree can be generated as a result.

As described above, according to the present invention, by using the representative characteristic amount extracted with respect to each form, the forms corresponding to the individual documents in the documents (bundle) read by the scanner 15 thereafter can be easily determined and identified at a high speed.

### (Document Read Processing)

In step 208, the read processing component 105 reads the documents (bundle) to be the target of the specific processing registered in advance by using the scanner 15. Here, the documents (bundle) are the documents (bundle) in which documents of a plurality of forms coexist, and the forms of the individual documents correspond to any of the registered forms. When the documents (bundle) to be read all have the same form, the form determination processing (S210) which will be described later is not needed.

As the procedure to the reading, first, a message or the like for encouraging the documents (bundle) desired to be read to be set in the scanner 15 is displayed on the display of the operation component 16. As the example of the message, “Set documents in the scanner. After setting, press the OK button.” and the like are cited.

The reading may be started at the moment when a user presses the OK button after setting the documents (bundle). Other than this, setting of the documents (bundle) in the scanner 15 is automatically recognized, by using a photo-interrupter provided at a lower portion of the document table, a document sensor of the document feeding device and the like, and the reading may be started simultaneously with the recognition.

### (Form Determination Processing)

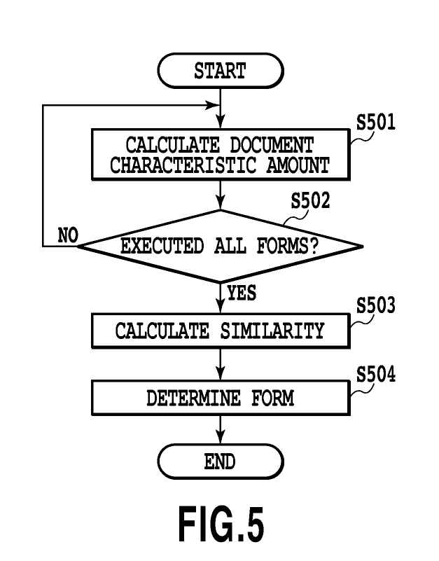

FIG. 5 is a flowchart showing the detail of a content of form determination processing in step 210.

First, in step 501, the form determination processing component 106 selects the first (arbitrary) form among the registered forms. Subsequently, extraction of the characteristic amount (hereinafter, called the document characteristic amount) corresponding to the representative characteristic amount of the selected form is performed for the first document of the documents (bundle) read in step 208. More specifically, extraction of the characteristic information of the same kind as the characteristic information of the representative characteristic amount is tried from the same position as the position specified by the positional information of the representative characteristic amount. Extraction is performed under the same conditions as the conditions at the time of the representative characteristic amount being extracted. More specifically, the conditions such as the resolution conversion rate in the resolution conversion processing, the threshold value in the background removal processing, the division size in the division processing and the characteristic information used in the characteristic amount generation processing, which are the same as those at the time of extraction of the representative characteristic amount, are used.

When the document characteristic amount extraction processing for the first form is finished, the next form is selected from the registered forms, and the similar processing is performed. This is repeated until the extraction of the document characteristic amount is finished for all the registered forms (S502).

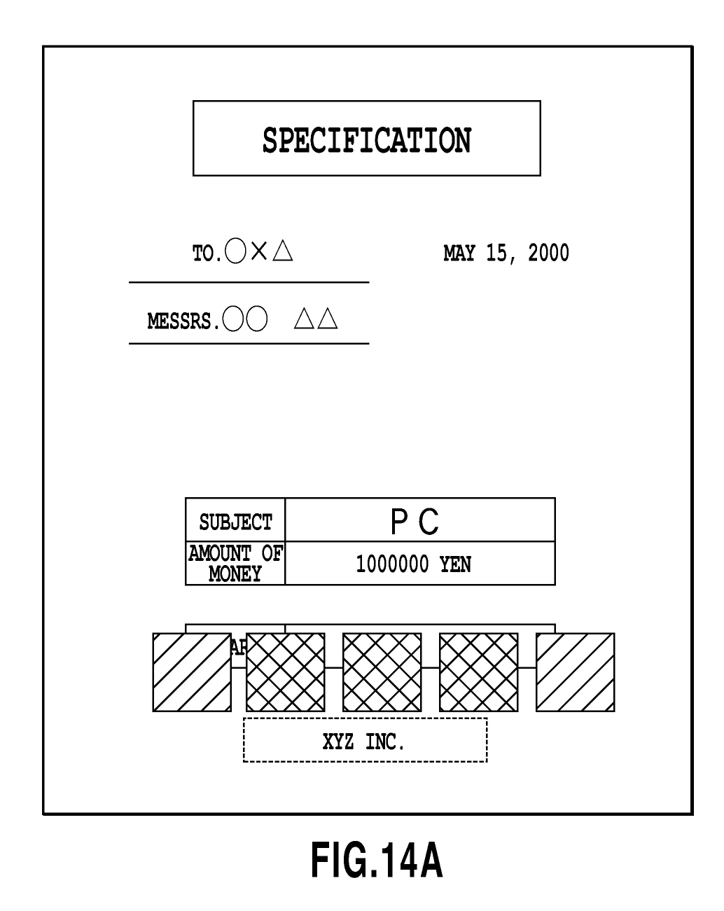

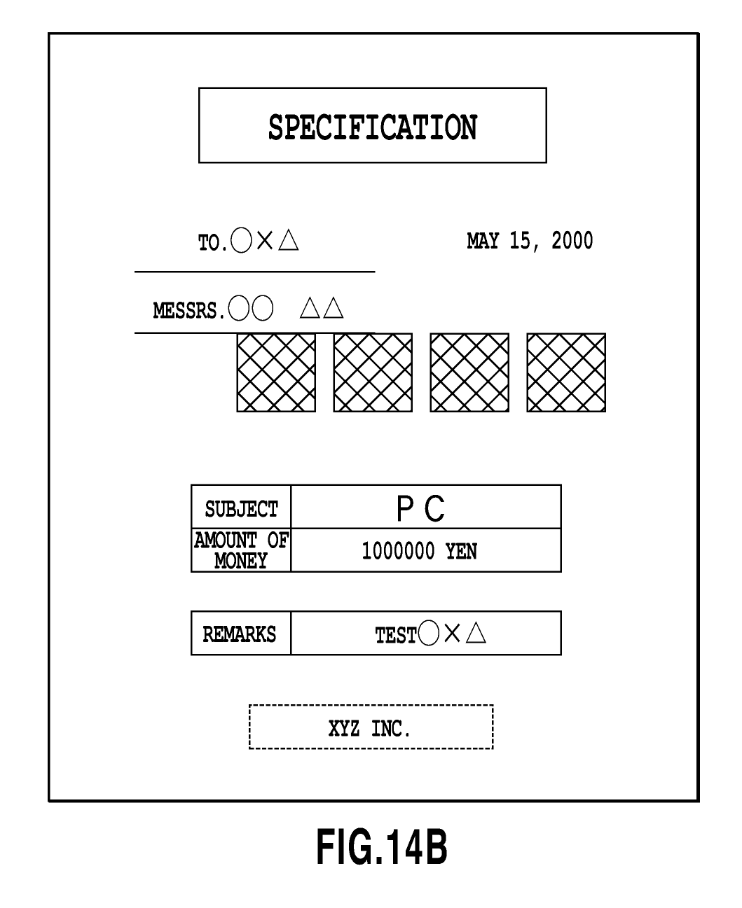

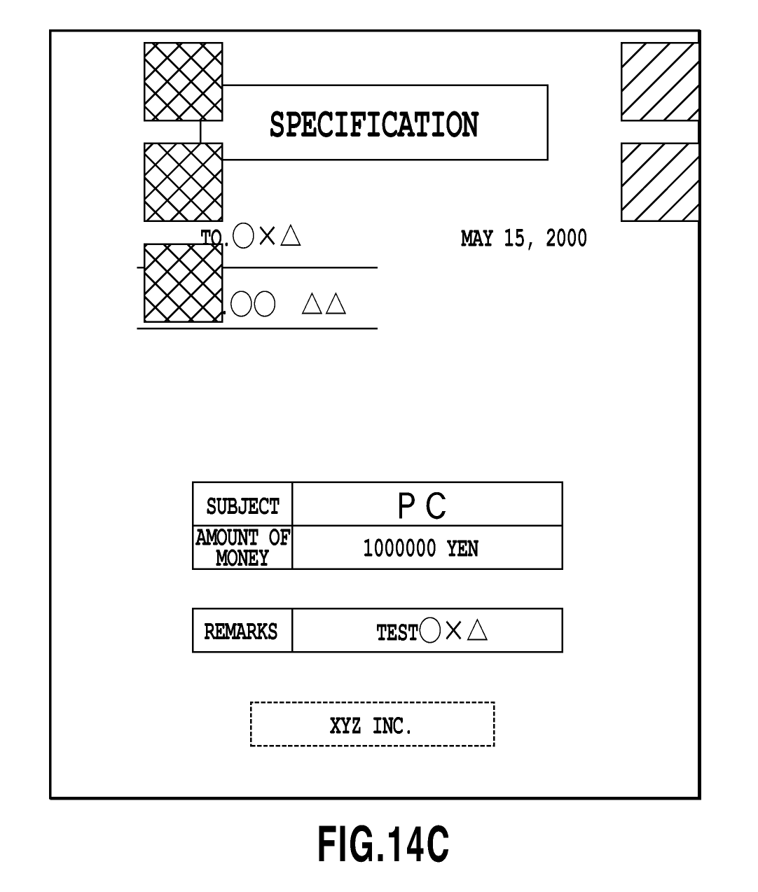

FIGS. 14A to 14C are examples each showing the extracted document characteristic amount when the read document is “specification”. The examples respectively show the document characteristic amount with respect to the representative characteristic amount of “specification” (FIG. 14A), the document characteristic amount with respect to the representative characteristic amount of “bill” (FIG. 14B), and the document characteristic amount with respect to the representative characteristic amount of “settlement” (FIG. 14C).

Further, in the stage of the document characteristic amount generation processing, the aforementioned weighting processing may be performed for the extracted characteristic information. Thereby, even if misregistration at the time of scan, or misregistration in printing the document itself occurs at the extraction stage of the document characteristic amount, the document characteristic amount which is effective to a certain degree can be generated.

In step 503, the form determination processing component 106 compares the extracted document characteristic amount and the representative characteristic amount to calculate similarity.

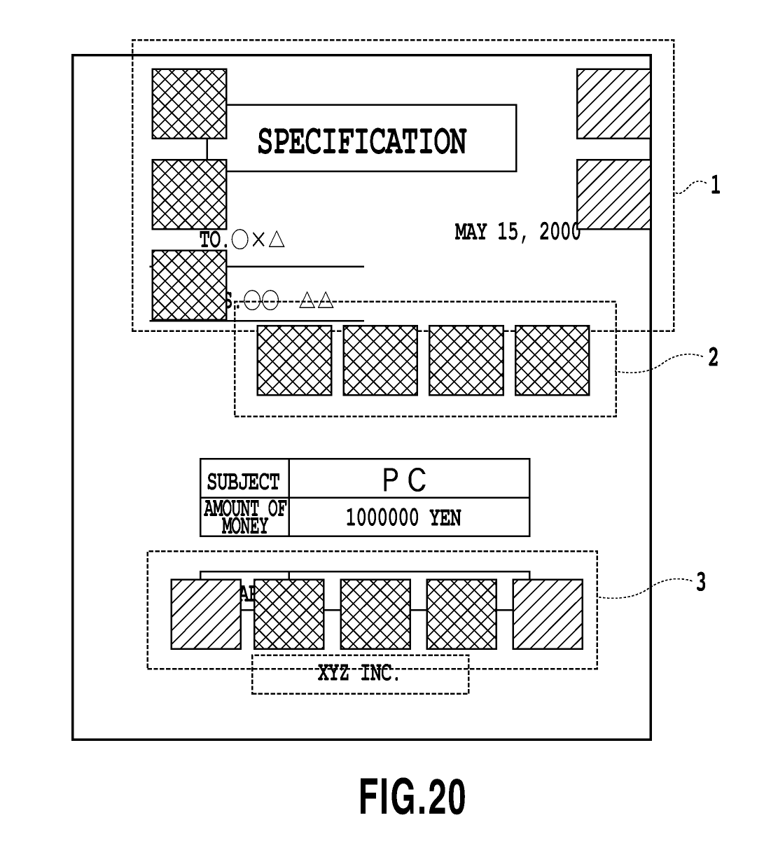

In the present embodiment, the characteristic information is the number of pixels with the pixel value of luminance being zero. Accordingly, the similarity in this case can be calculated by dividing the number of pixels in the document characteristic amount extracted for each region image by the number of pixels of the representative characteristic amount, with respect to all the region images in which the representative characteristic amount is present, and taking the average value of them. When the document and the form correspond to each other, the number of pixels of the document characteristic amount and the number of pixels of the representative characteristic amount should be substantially equal in all the region images, and therefore, the average value is a large numeral value. In contrast with this, if the form does not correspond to the document, the number of pixels of the document characteristic amount and the number of pixels of the representative characteristic amount cannot be substantially equal in all the regions, and therefore, the average value becomes small. Calculation of similarly is performed in the sequence of the smaller coordinates of the representative characteristic amount when the upper left of the document is set as the origin, for example. FIG. 20 shows an example of the calculation sequence of similarity. FIG. 20 shows the state in which the similarity to the representative characteristic amount of “settlement” having the smallest coordinates is calculated first, the similarity to the representative characteristic amount to “bill” with the next smallest coordinates is calculated next, and the similarity to the representative characteristic amount of “specification” is finally calculated

When the characteristic information is the number of pixels having some information like this, the similarity can be determined by the method as described above. If the characteristic information is the character information subjected to, for example, OCR processing, the similarity can be calculated by calculating the concordance rate of the character information as the representative characteristic amount and the character information as the extracted document characteristic amount. As the calculation method of the similarity, the method corresponding to the content of the characteristic information can be arbitrarily applied

After the calculation of the similarity is finished, the process proceeds to step 504.

In step 504, the form determination processing component 106 determines and specifies the optimal forms to the individual documents which are read, based on the calculated similarity. More specifically, from all the obtained similarities, the form with the highest similarity is determined as the form of the document.

As described above, when the number of region images configuring the representative characteristic amount is narrowed down, the form can be determined in a shorter time.

### (Registration Content Execution Processing)

Finally, in step 211, the registration content execution processing component 107 executes specified processing associated with the determined form (check of the presence or absence of affixation of a seal or the like) for the document read in step 208.

Subsequently, the execution result is displayed on the display of the operation component 16, for example, in accordance with the content registered in advance.

As above, the document determining apparatus of the present invention matches only the regions shown by the representative characteristic amount of each form with respect to the documents read from the documents (bundle) in which a plurality of kinds of forms coexist, and therefore, can determine the form of the documents at a high speed by simple processing. Further, in the document processing apparatus including the above described document determining apparatus, desired processing can be automatically performed for the document whose form is determined by registering the form with the specific processing associated with the form in advance.

### Embodiment 2

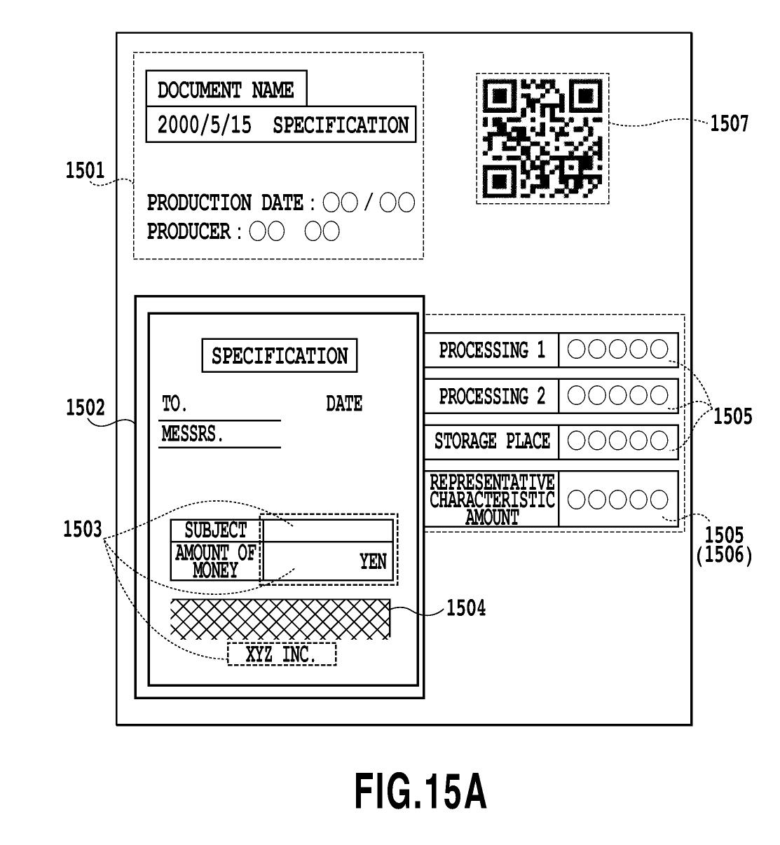

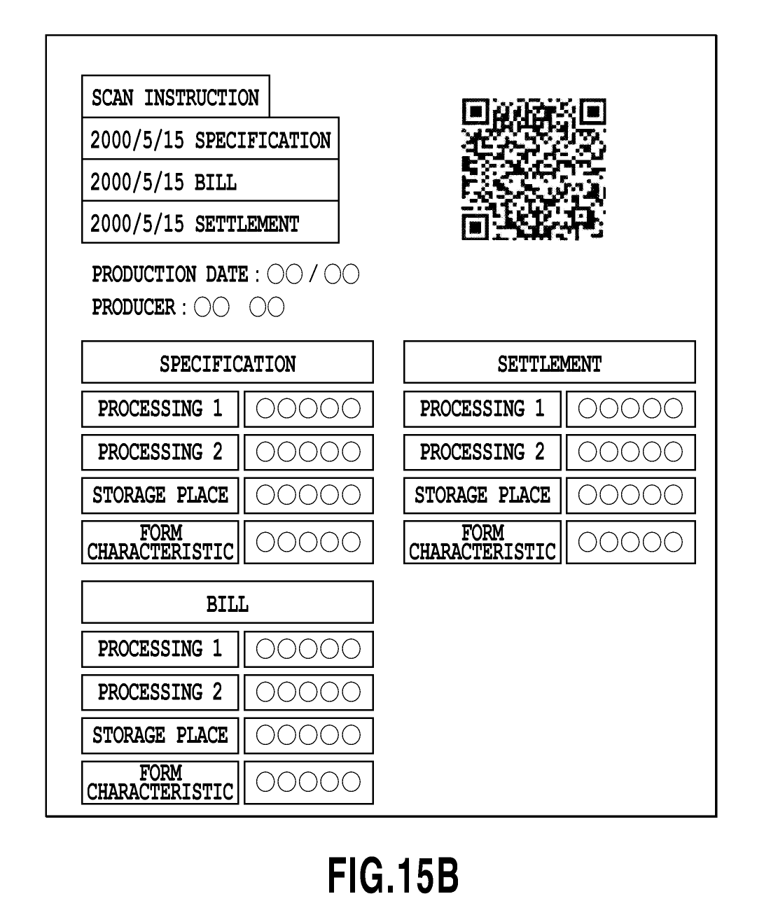

In embodiment 2, the image data as the form obtained by reading a blank document or the like, the content of the specific processing associated with the form, the representative characteristic amount of the form and the like are printed out onto a paper medium. In the present specification, the paper medium printed out is called “scan ticket”. FIG. 15A shows an example of the scan ticket. When the user desires to perform the same operation as the operation performed in the past, the user can efficiently perform the operation by using the scan ticket.

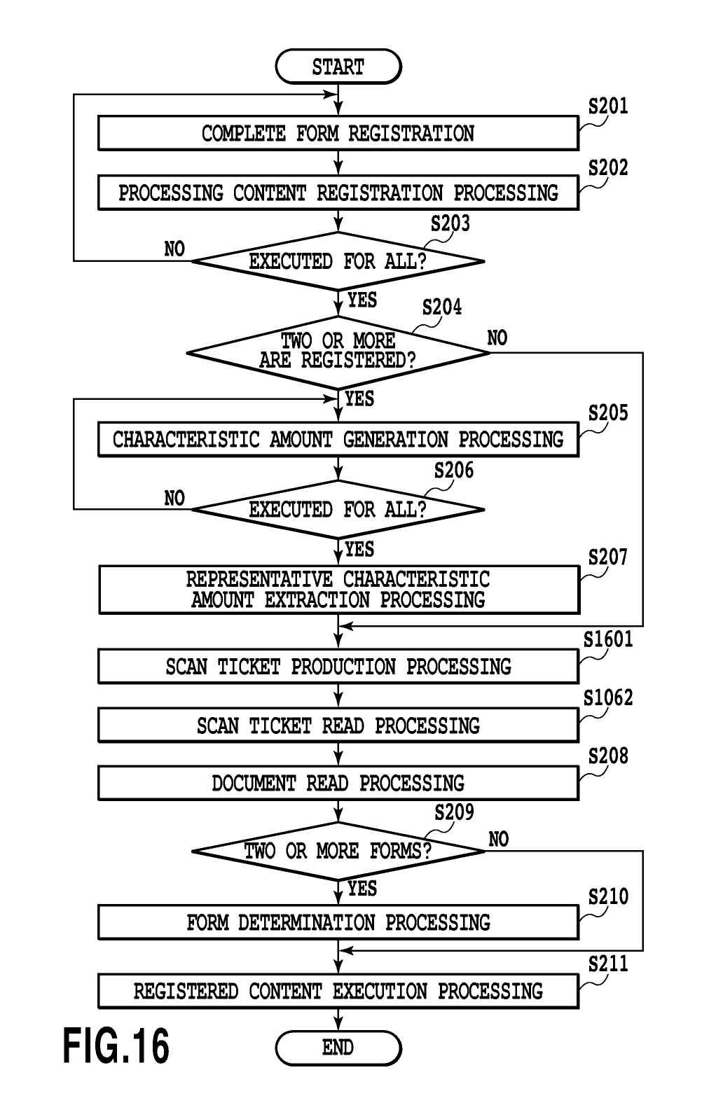

Hereinafter, an outline of the present embodiment will be described by following the flowchart of FIG. 16, and since most of the processing is common to the flowchart of FIG. 2 in embodiment 1, only the difference will be mainly described here.

The processing of registering the form of the document (S201), registering the specific processing content desired to be performed for each form (S202), going through the characteristic amount generation processing (S205) and extracting the representative characteristic amount of the form (S207) is the same as that of the case of embodiment 1.

When extraction of the representative characteristic amount is completed, the processing of producing the scan ticket is executed in a scan ticket producing processing component not illustrated, and the scan ticket is outputted by the printer 14 (S1601).

Subsequently, in accordance with the instruction of a user acquiring the scan ticket and confirming the description content, the information of the scan ticket is read in the scan ticket read processing component not illustrated (S1602).

Thereafter, based on the read information, the document read processing (S208), the form determination processing (S210) and the registered content execution processing (S211) are executed similarly to the case of embodiment 1.

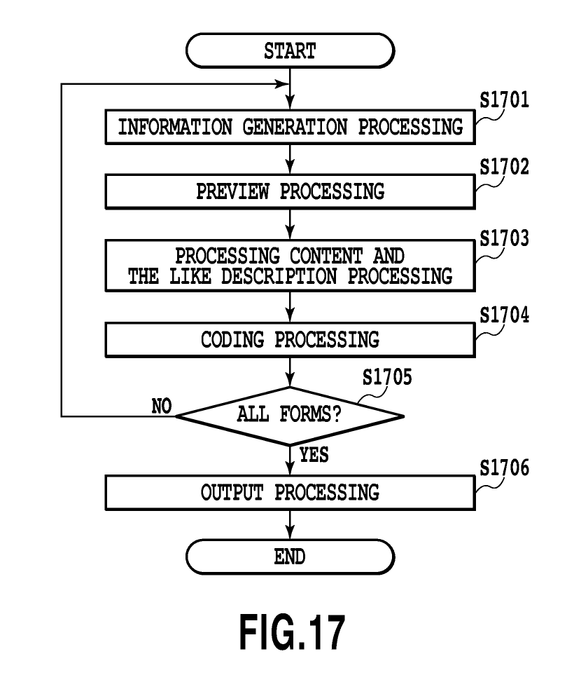

Here, the scan ticket production processing which is the feature of the present embodiment will be described in detail by using a flowchart of FIG. 17.

First, in step 1701, the scan ticket production processing component performs processing of generating bibliographical information. The bibliographical information includes the information such as the title, the production date and the producer of the scan ticket. The bibliographical information is generated based on the information of the image data registered as a form in the form registration processing (S201). The generated bibliographical information is finally described on the scan ticket as shown in 1501 of FIG. 15A.

Next, in step 1702, the scan ticket production processing component performs preview processing. In the preview processing, the entire form of the document registered in the form registration processing (S201) is displayed first. In the example of FIG. 15A, the entire form of “specification” is displayed (1502). Next, the location to be the target of the processing registered in the processing content registration processing (S202) is displayed. In the example of FIG. 15A, the regions where the subject column, the column of the amount of money, and the column of company name are enclosed by the broken lines respectively as the locations to be processed are displayed (1503). The representative characteristic amount extracted in the representative characteristic extraction processing (S204) is displayed based on the positional information. In the example of FIG. 15A, the representative characteristic amount is displayed as the region of the mesh pattern (1504).

Subsequently, in step 1703, the scan ticket production processing component performs processing of describing the processing content and the like. In concrete, the processing of describing the information of the other form simultaneously registered and the like is executed in addition to the content of the specific processing associated with a form, and the extracted representative characteristic amount. In the example of FIG. 15A, the information (1505) relating to the storage place of the content of the specific processing and the processing result and the information (1506) relating to the representative characteristic amount are described.

Next, in step 1704, the scan ticket production processing component performs coding processing. More specifically, the scan ticket production processing component codes the contents obtained by the information generation processing (S1701), the preview processing (S1702) and the processing of describing processing content and the like (S1703). As an example of coding, FIG. 15A shows the case of a QR code (1507). As a matter of course, in coding, a two-dimensional code and a one-dimensional code such as a barcode other than a QR code may be applied.

Subsequently, in step 1705, it is determined whether the data of the scan tickets about all the registered forms are produced, and when production of the data of the scan tickets about all the forms is completed, the process proceeds to step 1706.

In step 1706, the scan ticket production processing component outputs (prints out) the produced scan ticket data. In the case of the present embodiment, three scan tickets corresponding to “specification”, “bill” and “settlement” are printed out.

By using the scan ticket for each form obtained as above, the user performs desired processing for the documents (bundle) in which these three forms coexist. More specifically, by reading three scan tickets, the document processing apparatus acquires the information such as the specific processing content and the representative characteristic amount of each form, and thereafter, executes various kinds of processing for the read documents (bundle).

More detailed description is as follows.

First, before the read processing of the documents (bundle) (S205) is executed, the user is encouraged to read the scan ticket of the form corresponding to the documents (bundle) to be read hereafter. When the user sets the scan ticket in the scanner 15, and instructs scan ticket reading via the operation component 16, the QR code on the scan ticket is read. The read QR code is decoded, and the information such as the specific processing associated with the form and the representative characteristic amount is acquired. When the reading of all the scan tickets is finished, and the acquisition of various kinds of information on the scan ticket is finished, the user is subsequently encouraged to read the documents (bundle). After the user sets the documents (bundle) in the scanner 15, the reading is started, and the form determination processing (S210) for the read documents, and the registered content execution processing (S211) are performed.

In the above described scan ticket production processing (S1601), the case of producing the scan tickets according to the forms is described, but the scan ticket integrating a plurality of forms into one may be produced. FIG. 15B is an example of the scan ticket integrating the three forms of “specification”, “bill” and “settlement” into one. In the case of such a scan ticket, the read processing of the scan ticket (S1602) can be performed only a small number of times, and the management burden of the following scan tickets can be reduced.

In embodiment 2, the document processing apparatus in the case of using the scan ticket is described above. In embodiment 2, the individual document forms are easily determined, and desired processing can be performed by using the representative characteristic amount on the scan ticket.

### Embodiment 3

Next, an embodiment in which a user can directly designate a representative characteristic amount when the suitable representative characteristic amount cannot be properly extracted will be described as embodiment 3.

In embodiment 1, when the representative characteristic amount extracted in the representative characteristic amount extraction processing is determined as insufficient, the characteristic amount is calculated again by changing the characteristic information or the like, and the representative characteristic is extracted again. In the present embodiment, when the representative characteristic amount which is extracted again is still insufficient, a user can directly designate the characteristic information and the positional information configuring the representative characteristic amount.

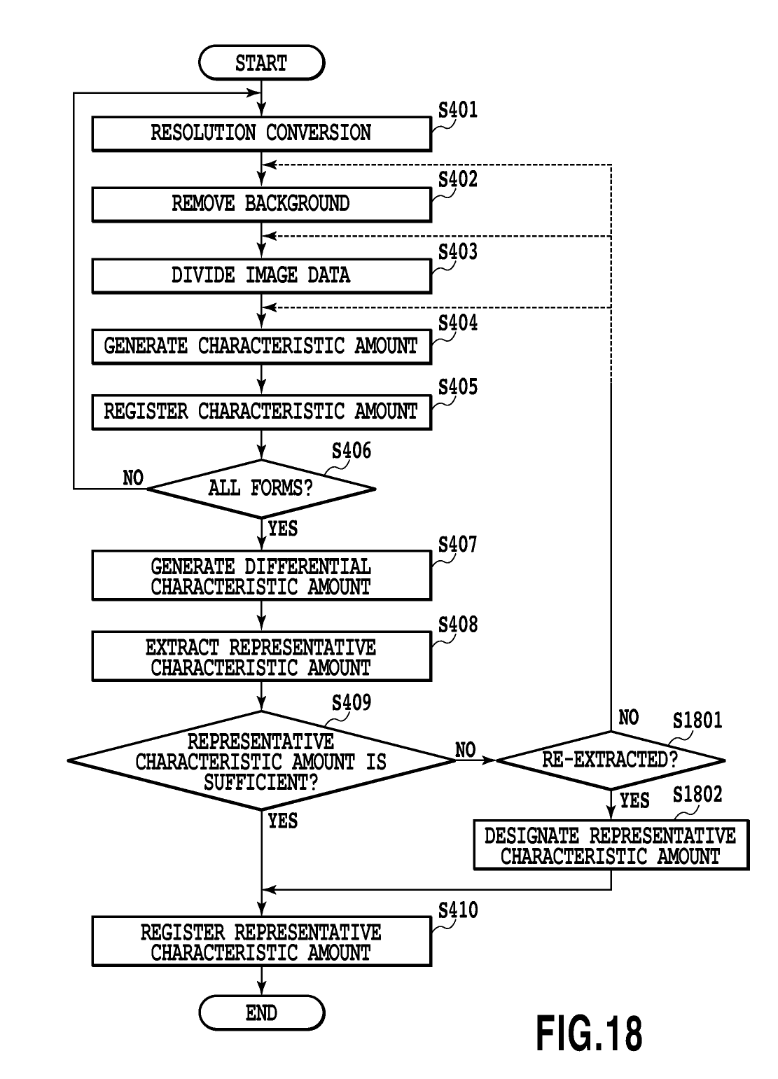

Hereinafter, an outline of the present embodiment will be described along the flowchart of FIG. 18, and most of the processing is common to the flowchart of FIG. 2 in embodiment 1, and therefore, only the difference is mainly described here.

When the representative characteristic amount is extracted in step 408, it is determined whether or not the extracted representative characteristic amount is sufficient in step 409. When it is determined as insufficient, the representative characteristic amount designation processing component not illustrated proceeds to step 1801 and determines whether or not the representative characteristic amount is the re-extracted one. More specifically, it is determined whether or not the representative characteristic amount determined as insufficient in step 409 is the representative characteristic amount which is re-extracted by changing the condition of the characteristic information. The re-extraction determination is performed by, for example, checking whether or not a specific flag is set at the representative characteristic amount or the like. More specifically, for the representative characteristic amount which becomes the re-extracted one in the representative characteristic amount extraction processing in step 408, the flag indicating, for example, re-extraction is added to the data of it, and the re-extraction is determined by checking the presence or absence of the flag. If the representative characteristic amount is not the re-extracted one, the process returns to any one of step 401 to step 409, and the re-extraction of the characteristic amount is performed. Meanwhile, if the representative characteristic amount is determined as the re-extracted one, the process proceeds to step 1802.

In step 1802, the representative characteristic amount designation processing component displays the screen for the user to designate the characteristic information and the positional information configuring the representative characteristic amount on the display of the operation component 16. First, in order to designate the characteristic information, the user selects the item which the user desires to designate from the items such as the pixel information, OCR and character attribute. Here, when the user selects, for example, OCR, the user is subsequently allowed to input the character (for example, “specification”) to be recognized as the representative characteristic amount. For input of the character, an arbitrary method can be applied such as displaying a touch panel type keyboard on the display of the operation component 16, for example. Subsequently, as for the positional information, for example, the entire image of the form is displayed on the display of the operation component 16, and (x, y) coordinates corresponding to the initial point and the end point of an arbitrary region are designated by a touch pen or the like. In the case of the designating method, by designating the two points that are the initial point and the end point, the rectangle passing through the two points can be made, and the inside of the rectangle is designated as the region of the representative characteristic amount.

As still another method, the representative characteristic amount may be designated by reading the document with the location to be the representative characteristic amount enclosed by a specific color in advance, by using the scanner 15. In this case, the representative characteristic amount designation processing component first displays the display to encourage setting of the document for designating the representative characteristic amount in the scanner on the display of the operation component 16. Subsequently, the representative characteristic amount designation processing component reads the set document, and executes the processing of definition of the characteristic information, detection of the closed region enclosed by a specific color, and calculation of the characteristic information in the closed region. Subsequently, the representative characteristic amount designation processing component extracts the representative characteristic amount with the place (coordinates) of the closed region as the positional information of the representative characteristic amount.

The characteristic information and the positional information which are directly designated by the user as described above are registered as the representative characteristic amount of the corresponding form in step 410.

By the method as above, the user can directly designate an arbitrary representative characteristic amount.

Thereby, even when a sufficient representative characteristic amount cannot be extracted, a suitable representative characteristic amount according to the intention of the user can be set.

### Embodiment 4

Further, as a modified example of embodiment 3, an embodiment in which a user directly designates the representative characteristic amount described in a scan ticket again to change the representative characteristic amount to an arbitrary content will be described as embodiment 4.

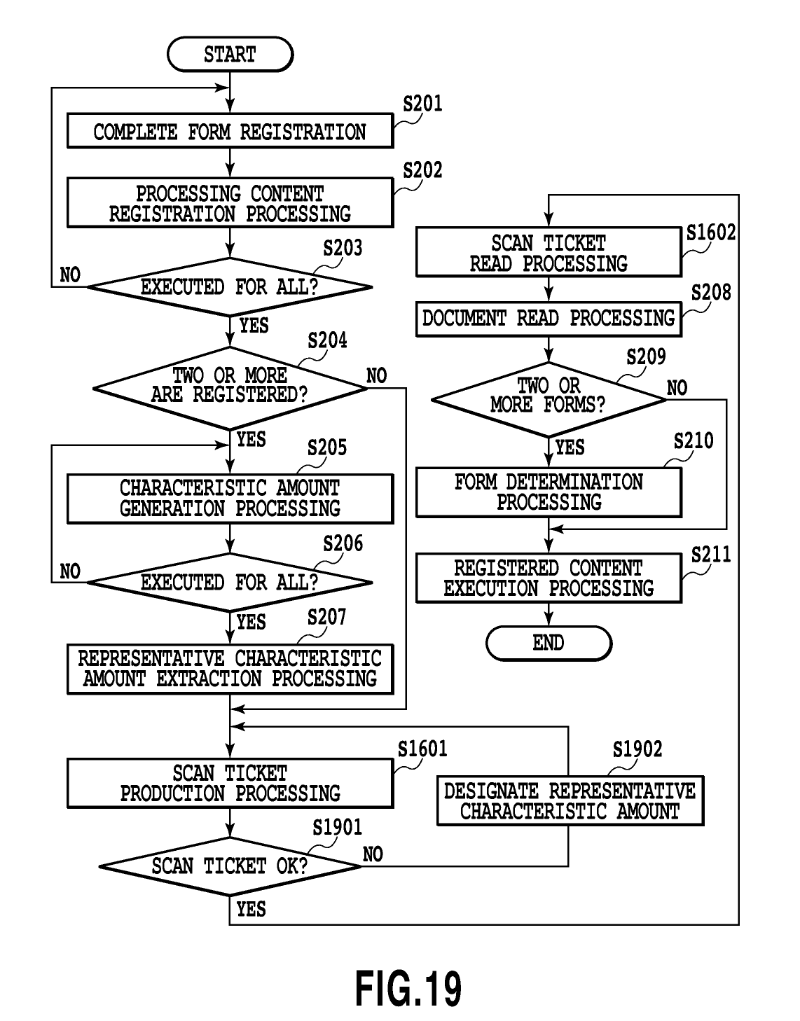

FIG. 19 is a flowchart expressing the processing of the case in which the user directly designates the representative characteristic amount, which is the feature of the present embodiment. However, step 201 to step 406 and step 208 to step 211 which are common to the flowchart of FIG. 16 are omitted. Hereinafter, the description will be made along the flowchart of FIG. 19.

In the present embodiment, a user first confirms the content of the scan ticket which is printed out in step 1601, and checks whether or not the representative characteristic amount is suitable.

In step 1901, the instruction to seek the user's determination is displayed on the display of the operation component 16, and the user instructs whether or not the scan ticket is suitable. If the produced scan ticket has no problem, the instruction to that effect is inputted by the user, and the process goes to step 1602. Meanwhile, if the user is not satisfied with the representative characteristic amount of the produced scan ticket, or the user determines that the representative characteristic amount becomes better if the user adopts different characteristic information, the instruction for changing the scan ticket is inputted by the user, and the process proceeds to step 1902.

In step 1902, the representative characteristic amount designation processing component not illustrated displays the screen for the user to designate the characteristic information and the position information directly, on the display of the operation component 16 as in embodiment 3. Thereby the user directly inputs desired characteristic information or positional information.

As above, based on the characteristic information and the positional information directly designated by the user, the scan ticket is produced again in step 1601.

Thereby, a user can arbitrarily change the representative characteristic amount of the scan ticket automatically produced, and the intention of the user can be reflected more.

### Embodiment 5

Next, an embodiment of using the form registered in the image processing apparatus again will be described as embodiment 5.

For example, if the information relating to the registered form and the like is kept to be left in the storage component (HDD 13 or the like), the user can perform processing by directly using the registered information when the user wants to perform the same processing at a later date. The information which is left contains the image data as the form, the characteristic amount, the representative characteristic amount and the processing content. If the respective forms are individually registered, the processing using only some of the registered forms (only “specification” and “settlement” in the concrete example of embodiment 1) can be performed. Likewise, when the same processing is performed again within the range of the form already registered, the form can be reused without performing additional special processing. If the specific form is desired to be used by changing the processing content of the form, the registered information of the processing content of the form is called, and the processing content is edited to be an arbitrary processing content.

However, when in addition to the documents produced in the registered forms, a document produced in a form different from them is desired to be simultaneously processed, the registered form cannot be directly used. For example, when the documents (bundle) in which “attendance record” the form of which is not registered yet is added are desired to be processed, the registered forms of “specification”, “bill” and “settlement” cannot directly used. This is because the representative characteristic amounts which are registered by being associated with the forms are the result of extraction of the differences which enable discrimination among “specification”, “bill” and “settlement”, and the relation with “attendance record” is not considered. Accordingly, in the case of the above described example, the representative characteristic amounts which enable discrimination from the other forms among four documents with “attendance record” added to “specification”, “bill” and “settlement” need to be extracted again.

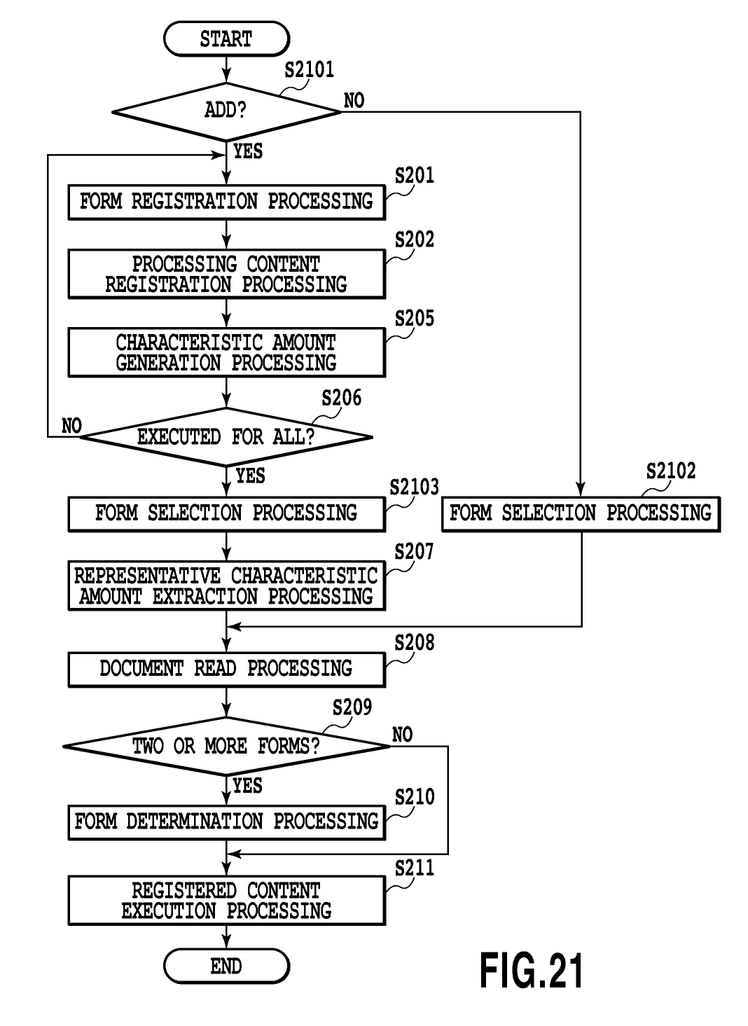

Hereinafter, the embodiment which makes it possible to perform processing by adding the unregistered form to the registered form will be described with reference to the flowchart of FIG. 21. In this case, the description of the parts common to the content described in the other embodiments will be omitted or simplified, and the difference will be mainly described.

First, in step 2101, the user instructs whether to perform processing by using only the registered form via the operation component 16. In the present embodiment, the form of “attendance record” is added, and therefore, the instruction to add a new one is inputted. When there is no form to be added and the processing is performed within the range of the registered forms, the process proceeds to step 2102.

In step 2102, a form reuse processing component not illustrated displays a list of the registered forms on the display of the operation component 16, and encourages the user to select the form to be used. When the user finishes selection of a desired form, the representative characteristic amount and the processing content registered by being associated with the selected form are read from the storage component (HDD 13 or the like), and predetermined processing is executed by using them. More specifically, the read processing of a document (S208), the form determination processing (S210) and the registered content execution processing (S211) are executed based on the selected form.

Meanwhile, in step 2101, when the user instructs to add another form, the form registration processing (S210), the processing content registration processing (S202) and the characteristic amount generation processing (S205) are performed for the form which the user wants to add newly. When a plurality of forms are added, the above described respective processing is performed for all of them (S206), the process proceeds to step 2103. In the present embodiment, the above described respective processing is executed for the form of “attendance record”.

In step 2103, the form reuse processing component displays a list of the registered forms on the display of the operation component 16, and encourages the user to select forms. In the case of the present embodiment, three forms that are “specification”, “bill” and “settlement” are selected. When the user selects desired forms, the process proceeds to step 207.

In step 207, the representative characteristic amount extraction processing is executed between the form newly added and registered and the selected registered forms. In the case of the present embodiment, by using the characteristic amount of the form of “attendance record” which is newly added, and the respective characteristic amounts of the respective forms of “specification”, “bill” and “settlement”, each processing of steps 407 to step 410 of FIG. 4 is executed. As a result, the representative characteristic amounts for uniquely identifying the respective forms are extracted. When the calculation condition of the characteristic amount of the newly registered form (for example, the divided size of the image data) differs from the calculation condition of the characteristic amounts of the registered forms, calculation processing of the characteristic amount is performed again for the registered forms, and thereafter, the representative characteristic amount can be extracted. After the extraction of the representative characteristic amount, the processing of step 208 and the following steps are sequentially executed as in the case of the other embodiments.

As above, even when a new form is added, the forms already registered can be reused by only performing the minimum additional processing.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example via a network or from a recording medium of various types serving as the memory device (e.g., computer-readable medium).

While the preset invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-279578, filed Dec. 9, 2009, which is hereby incorporated by reference herein in its entirety.

What is claimed is:

1. An image processing apparatus, comprising:
a form registration component configured to register a plurality of document forms;
a characteristic amount generation component configured to generate respective characteristic amounts of the plurality of the document forms registered in the form registration component;
a representative characteristic amount extraction component configured to extract a difference between the plurality of the document forms as a representative characteristic amount which is used for identifying the forms, by using the generated characteristic amount;
a reading component configured to read a document to be checked; and
a form determination component configured to determine which document form among the plurality of document forms registered in the form registration component corresponds to the document to be checked that is read by the reading component, by using the representative characteristic amount extracted by the representative characteristic amount extraction component.

2. The image processing apparatus according to claim 1, wherein the form registration component registers image data of a plurality of document as the forms, and
the characteristic amount generation component includes:
a component configured to perform a resolution conversion processing for the registered image data;
a component configured to perform a background removal processing for the image data the resolution of which is converted; and
a region division component configured to perform processing of dividing the image data subjected to the background removal processing into region images each having a predetermined size,
wherein the characteristic amount is generated for each of the region images divided by the region division component.

3. The image processing apparatus according to claim 1, wherein the characteristic amount comprises positional information and characteristic information, wherein
the positional information includes information showing a position on a document of each region image divided by the region division component, and
the characteristic information includes any one of pixel information of luminance or brightness, character information subjected to OCR processing, color information, histogram, and attribute information of a halftone dot or a font, in the each region image divided by the region division component.

4. The image processing apparatus according to claim 2, further comprising:
a determination component configured to determine whether the extracted representative characteristic amount is sufficient as the representative characteristic amount used in the form determination component for determining which document form among the plurality of the registered document forms corresponds to the document to be checked that is read by the reading component, wherein when the extracted representative characteristic amount is determined as insufficient by the determination component, the characteristic amount generation component changes a condition to generate a characteristic amount, wherein
the changed condition includes any one of a resolution conversion rate in the resolution conversion processing, a threshold value in the background removal processing, and a divided size in the region division processing.

5. The image processing apparatus according to claim 3, further comprising:
a determination component configured to determine whether the extracted representative characteristic amount is sufficient as the representative characteristic amount used in the form determination component for determining which document form among the plurality of the registered document forms corresponds to the document to be checked that is read by the reading component, wherein
when the extracted representative characteristic amount is determined as insufficient by the determination component, the characteristic amount generation component changes a condition to generate a characteristic amount, wherein the changed condition includes the characteristic information.

6. The image processing apparatus according to claim 3, wherein the characteristic amount is generated for each of the divided region images by further performing weighting processing using a characteristic amount of a peripheral region.

7. The image processing apparatus according to claim 2, wherein the form determination component includes a document characteristic amount extraction component configured to extract a document characteristic amount corresponding to positional information and characteristic information of the representative characteristic amount from the document to be checked read by the reading component, wherein
the positional information includes information indicating a position on a document of the each region image divided by the region division component, and
the characteristic information includes any one of pixel information of luminance or brightness, character information with OCR processing applied, color information, histogram, and attribute information of a halftone dot or a font in the each region image divided by the region division component, wherein
the form of the document read by the reading component is determined by comparing the document characteristic amount extracted by the document characteristic amount extraction component and the representative characteristic amount of each form registered in the form registration component.

8. The image processing apparatus according to claim 7, wherein the document characteristic amount extraction component extracts the document characteristic amount in the same condition as a condition when the representative characteristic is extracted, wherein the condition includes any one or combination of a resolution conversion rate in the resolution conversion processing, a threshold value in the background removal processing, a divided size in the division processing and characteristic information used in the characteristic amount generation processing.

9. The image processing apparatus according to claim 7, wherein the document characteristic amount extraction component extracts the document characteristic amount by further performing weighting processing using a characteristic amount of a peripheral region.

10. The image processing apparatus according to claim 1, wherein the representative characteristic amount extracted by the representative characteristic amount extraction component is extracted from a region, in which a user does not write, of a document to be checked corresponding to the document form.

11. An image processing apparatus, comprising:
a form registration component configured to register a plurality of document forms;
a characteristic amount generation component configured to generate respective characteristic amounts of the plurality of the document forms registered in the form registration component;
a representative characteristic amount extraction component configured to extract a difference between the plurality of the document forms as a representative characteristic amount which is used for identifying the forms, by using the generated characteristic amount;
a storage component configured to store processing instruction information for performing check processing of a described matter of the document form and the representative characteristic amount by associating the processing instruction information with the representative characteristic amount;
a reading component configured to read a document to be checked;
a form determination component configured to determine which document form among the plurality of the document forms registered in the form registration component corresponds to the document to be checked that is read by the reading component, by using the representative characteristic amount extracted by the representative characteristic amount extraction component; and
a check component configured to check an described matter of the document to be checked by using the processing instruction information stored in the storage component by being associated with the document form determined by the form determination component.

12. The image processing apparatus according to claim 11, further comprising:
a scan ticket producing component configured to produce a scan ticket describing the document form, a content of specific processing written in the form, and the representative characteristic amount of the form.

13. The image processing apparatus according to claim 11, further comprising:
a representative characteristic amount instruction component configured to generate the representative characteristic amount in accordance with an instruction of a user; and
a user interface for a user to input the instruction.

14. The image processing apparatus according to claim 11, further comprising:
a form selecting component configured to allow a user to select an arbitrary form from registered forms, wherein the representative characteristic amount extraction component extracts a representative characteristic amount which enables discrimination between the newly registered form and the form selected by the form selection component for each form, and
the form determination component determines which document form among the registered document forms corresponds to the document to be checked that is read by the reading component, by using the representative characteristic amount extracted for each of the forms.

15. The image processing apparatus according to claim 11, wherein the representative characteristic amount extracted by the representative characteristic amount extraction component is extracted from a region, in which a user does not write, of a document to be checked corresponding to the document form.

16. An image processing method, the method comprising the steps of:
registering a plurality of document forms by a form registration component;
generating respective characteristic amounts of the plurality of the document forms registered by the form registration component by a characteristic amount generation component;
extracting a difference between the plurality of the document forms as a representative characteristic amount for use in performing discrimination of forms by using the generated characteristic amount, by a representative characteristic amount extraction component;
reading a document to be checked by a reading component; and
determining which document form among the plurality of the document forms registered by the form registration component corresponds to the document to be checked that is read by the reading component by using the representative characteristic amount extracted by the representative characteristic amount extraction component, by a form determination component.

17. An image processing method, the method comprising the steps of:
registering a plurality of document forms by a form registration component;
generating respective characteristic amounts of the plurality of the document forms registered by the form registration component by a characteristic amount generation component;
extracting a difference between the plurality of the document forms as a representative characteristic amount for use in performing identification of forms by using the generated characteristic amount, by a representative characteristic amount extraction component;
associating processing instruction information for performing check processing of a described matter of the document form with the representative characteristic amount and storing them, by a storage component;
reading a document to be checked by a reading component;
determining which document form among the plurality of the document forms registered by the form registration component corresponds to the document to be checked that is read by the reading component by using the representative characteristic amount extracted by the representative characteristic amount extraction component, by a form determination component; and
checking the described matter of the document to be checked by using the processing instruction information stored in the storage component by being associated with the document form determined by the form determination component, by a check component.

18. A computer-readable recording medium having computer-executable instructions for performing an image processing method, the method comprising the steps of:
registering a plurality of document forms by a form registration component;
generating respective characteristic amounts of the plurality of the document forms registered by the form registration component by a characteristic amount generating component;
extracting a difference between the plurality of the document forms as a representative characteristic amount for use in performing identification of forms by using the generated characteristic amount, by a representative characteristic amount extraction component;
associating storing processing instruction information for performing check processing of a described matter of the document form with the representative characteristic amount and storing them, by a storage component;
reading a document to be checked by a reading component;
determining which document form among the plurality of the document forms registered by the form registration component corresponds to the document to be checked that is read by the reading component by using the representative characteristic amount extracted by the representative characteristic amount extraction component, by a form determination component; and
checking the described matter of the document to be checked by using the processing instruction information stored in the storage component by being associated with the document form determined by the form determination component, by a check component.
